(19) United States
(12) Patent Application Publication
(10) Pub. No.: US 2026/0148316 A1
(43) Pub. Date: May 28, 2026

(54) METHODS AND SYSTEMS FOR TRACKING SPATIAL FLOW DIRECTIONS OF CARBON EMISSIONS IN ENERGY INDUSTRY CHAIN

(71) Applicant: BEIJING JIAOTONG UNIVERSITY, Beijing (CN)

(72) Inventors: Lin PENG, Beijing (CN); Junjie LI, Beijing (CN); Yulong YAN, Beijing (CN)

(73) Assignee: BEIJING JIAOTONG UNIVERSITY, Beijing (CN)

(21) Appl. No.: 19/304,596

(22) Filed: Aug. 20, 2025

(30) Foreign Application Priority Data
Nov. 27, 2024 (CN) 202411709256.X

(51) Int. Cl. G06Q 50/06; G06F 17/11; G06Q 40/12

(52) U.S. Cl. CPC G06Q 50/06; G06F 17/11; G06Q 40/12

(57) ABSTRACT

The present disclosure discloses a method and system for tracking spatial flow directions of carbon emissions in an energy industry chain. The method comprises the following steps. S1, a spatialized full-life-cycle carbon emission accounting model for an energy production and consumption of a primary energy and a secondary energy is constructed. S2, a full-life-cycle carbon emission spatial flow tracking model for a two-stage production and consumption from the primary energy to the secondary energy, and a one-stage production and consumption of the secondary energy is constructed. S3, a spatialized full-life-cycle carbon emission dataset and a full-life-cycle carbon emission spatial flow dataset of the energy production and consumption that meet quality evaluation requirements are determined.

### CROSS-REFERENCE TO RELATED APPLICATIONS

This application claims priority to Chinese Patent Application No. 202411709256.X, filed on Nov. 27, 2024, the entire content of which is incorporated herein by reference.

### TECHNICAL FIELD

The present disclosure relates to the technical field of information management, and in particular, to a method and system for tracking spatial flow directions of carbon emissions in an energy industry chain.

### BACKGROUND

The energy industry chain involves a plurality of stages, covering a full-life-cycle process from primary energy production to secondary energy conversion and finally to final energy consumption. The primary energy production stage involves the extraction and preliminary processing of natural resources such as coal, petroleum, natural gas, and renewable energy sources (e.g., solar energy, wind energy, and nuclear energy). The secondary energy conversion stage involves converting the primary energy, through physical or chemical means, into energy forms that are more convenient for storage, transportation, and use (e.g., electricity, thermal energy, and refined oil). The final energy consumption stage involves the actual consumption and utilization of converted energy products in fields such as industry, transportation, construction, and residential life.

In the energy industry chain, the embedded carbon emissions over the full-life-cycle of energy products may shift among regions as a result of industrial demand, trade division, and economic activity. Therefore, tracking and analyzing the flow directions of full-life-cycle carbon emissions of energy products along the energy industry chain has become an important direction in carbon emission research.

### SUMMARY

One or more embodiments of the present disclosure provide a method for tracking spatial flow directions of carbon emissions in an energy industry chain. The method comprises the following steps. In steps S1, a primary energy production, a secondary energy conversion, and a final energy consumption process corresponding to spatial locations at specific sites are modeled based on a general multi-flow multi-node model to construct a spatialized full-life-cycle carbon emission accounting model for an energy production and consumption of a primary energy and a secondary energy. In steps S2, based on the spatialized full-life-cycle carbon emission accounting model of the energy production and consumption, flow characteristics of carbon emissions between regions along the energy industry chain of the primary energy production—the secondary energy conversion—the final energy consumption process under different application scenarios are determined, and a full-life-cycle carbon emission spatial flow tracking model for a two-stage production and consumption from the primary energy to the secondary energy, and a one-stage production and consumption of the secondary energy is constructed. In steps S3, based on an accounting object, an initial dataset of the energy industry chain is determined. The initial dataset of the energy industry chain is substituted into the spatialized full-life-cycle carbon emission accounting model for the energy production and consumption of the primary energy and the secondary energy, and into the full-life-cycle carbon emission spatial flow tracking model for the two-stage production and consumption from the primary energy to the secondary energy and the one-stage production and consumption of the secondary energy, to determine a spatialized full-life-cycle carbon emission dataset and a full-life-cycle carbon emission spatial flow dataset of the energy production and consumption that meet quality evaluation requirements.

The above-described method may bring the following advantageous effects:

1. The present disclosure is intended to improve the current carbon emission accounting system of the energy industry chain, particularly by determining the spatial geographic locations where primary energy production, secondary energy conversion, and final energy consumption process occur under different application scenarios, and by clarifying the flow characteristics and spatial flow quantities of carbon emissions along the energy industry chain of the primary energy production—the secondary energy conversion—the final energy consumption process, so as to enhance the comprehensiveness and accuracy of carbon emission accounting in the energy industry chain and provide a scientific basis for formulating more detailed and systematic energy and environmental policies.

2. The present disclosure exhibits general applicability in spatialized full-life-cycle carbon emission accounting for energy production and consumption and is capable of identifying the spatial distribution characteristics of embedded carbon emissions from both production and consumption perspectives.

3. The present disclosure also exhibits general applicability in tracking the spatial flow directions of full-life-cycle carbon emissions of energy flows, and is capable of tracking the spatial cross-stage transfer characteristics of embedded carbon emissions along the energy industry chain from primary energy production to secondary energy conversion and then to final energy consumption under different application scenarios.

4. The present disclosure features simple operation, strong practical applicability, and wide applicability scope, and effectively improves the comprehensiveness and accuracy of carbon emission accounting for embedded carbon emissions in the energy industry chain.

### BRIEF DESCRIPTION OF THE DRAWINGS

The present disclosure will be further described by way of exemplary embodiments, which are illustrated in detail with reference to the accompanying drawings. These embodiments are not intended to be limiting. In these embodiments, identical reference numerals indicate identical structures, wherein:

FIG. 1 is a schematic diagram illustrating an application scenario of a system for tracking spatial flow directions of carbon emissions in an energy industry chain according to some embodiments of the present disclosure;

FIG. 2 is a flowchart of an exemplary process for a method for tracking spatial flow directions of carbon emissions in an energy industry chain according to some embodiments of the present disclosure; and

FIG. 3 is a flowchart of an exemplary process for determining a spatialized full-life-cycle carbon emission dataset and a full-life-cycle carbon emission spatial flow dataset according to some embodiments of the present disclosure.

### DETAILED DESCRIPTION

In order to more clearly illustrate the technical solutions of the embodiments of the present disclosure, a brief introduction of the drawings used in the description of the embodiments is provided below. Obviously, the drawings described below are merely some examples or embodiments of the present disclosure. Those of ordinary skill in the art may apply the present disclosure to other similar scenarios based on these drawings without creative efforts. Unless otherwise indicated or apparent from the context, identical reference numerals in the figures represent identical structures or operations.

It should be understood that the terms “system,” “device,” “unit,” and/or “module” used herein are merely methods for distinguishing components, elements, parts, portions, or assemblies at different levels. However, if other terms can achieve the same purpose, such terms may be substituted accordingly.

As used in the present disclosure and the claims, unless the context clearly indicates otherwise, words such as “a,” “an,” “one,” and/or “the” are not limited to the singular and may also include the plural. In general, the terms “include” and “contain” indicate the inclusion of the explicitly stated steps or elements, but such inclusion is not exclusive, and the manner or device may also include other steps or elements.

Flowcharts are used in the present disclosure to illustrate operations performed by systems according to embodiments of the present disclosure. It should be understood that the preceding or subsequent operations are not necessarily executed in the exact order described. Instead, the operations may be executed in reverse order or in parallel. In addition, other operations may be added to these processes, or one or more operations may be removed from these processes.

At present, there are two primary manners for quantifying the transfer of embedded carbon emissions across different regions: one is the life cycle assessment manner, and the other is the input-output model manner. The life cycle assessment manner has developed two spatial flow tracking modes for carbon emissions: top-down and bottom-up, thereby enabling the tracing of spatial transfer characteristics of embedded carbon emissions from the perspective of energy consumption. The top-down spatial flow tracking mode for carbon emissions is typically represented by environmentally extended multi-regional input-output models, while the bottom-up spatial flow tracking mode for carbon emissions is typically represented by manners such as direct trade accounting, point flow simulation, and ecological network analysis. Compared with the life cycle assessment manner and derivative manners, the input-output model (including single-region input-output models, multi-regional input-output models, and bilateral trade embedded emission models) has been widely applied in the analysis of spatial transfer of carbon emissions. However, most input-output models focus only on quantitatively characterizing the spatial transfer characteristics of embedded carbon emissions associated with a single type of material or energy flow in the full-life-cycle, and are incapable of spatially tracking and integrating all embedded carbon emissions across different stages. Meanwhile, input-output models typically use monetary flows between regions as proxies for actual material and energy flows, resulting in limited accuracy in the accounting results. Taking the power industry as an example, most input-output models only examine the carbon emissions during the power production stage and the transfer of embedded carbon emissions during power transmission, while failing to characterize the embedded carbon emissions from the production and transportation of upstream fuel, such as coal. As a result, the flow characteristics of carbon emissions along the energy industry chain of coal mining-coal-fired power generation-coal power consumption across different regions remain unclear. Therefore, there is an urgent need for a method for tracking carbon emissions that is capable of identifying the flow directions of the energy industry chain across different regions.

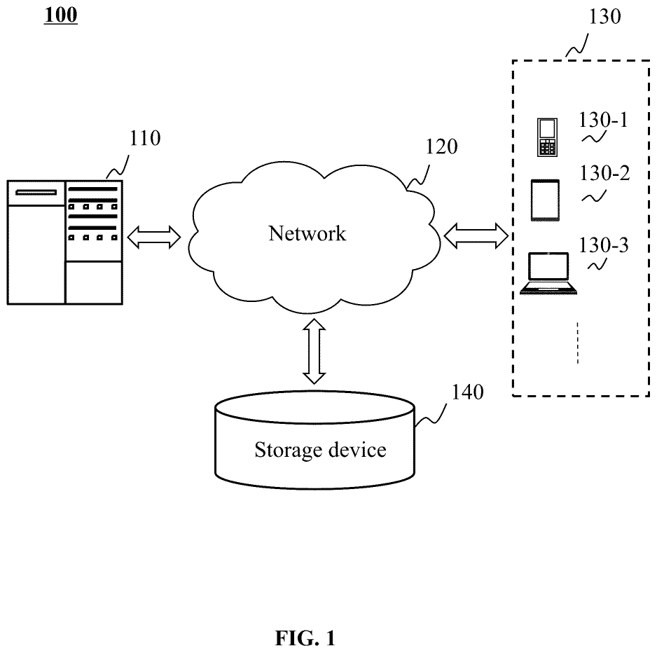

FIG. 1 is a schematic diagram illustrating an application scenario of a system for tracking spatial flow directions of carbon emissions in an energy industry chain according to some embodiments of the present disclosure. As illustrated in FIG. 1, an application scenario 100 of a system for tracking spatial flow directions of carbon emissions (hereinafter referred to as application scenario 100) may include a processing device 110, a network 120, a terminal 130, and a storage device 140. The system for tracking spatial flow directions of carbon emissions may be used to implement the manners and/or processes disclosed in the present disclosure.

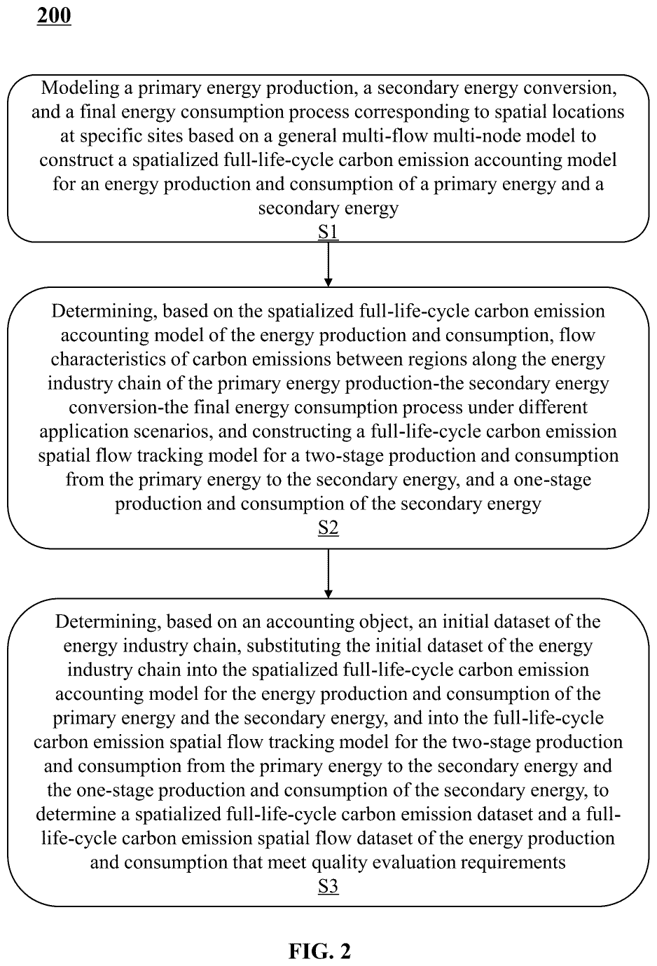

The processing device 110 may be used to process data and/or information from various components of the application scenario 100 and/or from external data sources. The processing device 110 may execute program instructions based on such data, information, and/or processing results so as to perform one or more functions described in the present disclosure. For example, the processing device 110 may execute the process 200 shown in FIG. 2.

In some embodiments, the processing device 110 includes a processor, a memory, a communication interface, and a bus that are connected via the bus to enable communication among the processor, the memory, and the communication interface. In some embodiments, the processing device 110 may be local or remote. In some embodiments, the processing device 110 may be implemented on a cloud platform. Merely by way of example, the cloud platform may include a private cloud, a public cloud, a hybrid cloud, or any combination thereof. In some implementations, the processor may be various types of general-purpose processors such as a central processing unit (CPU), a digital signal processor (DSP), or the like, which is not limited herein.

The network 120 may include any suitable network configured to facilitate exchange of information and/or data. In some embodiments, one or more components of the application scenario 100 may exchange information and/or data via the network 120. For example, the processing device 110 may obtain production data, conversion data, consumption data, flow data of energy products, and embedded carbon emission intensity data via the network 120 to form an initial dataset of the energy industry chain. The network 120 may include a local area network (LAN), a wide area network (WAN), a wired network, a wireless network, or any combination thereof.

The terminal 130 refers to one or more terminal devices used by users. In some embodiments, the users include entities providing primary energy (e.g., coal mining enterprises, local energy companies), entities consuming secondary energy such as electricity (e.g., large enterprises, residential electricity users), or the like. In some embodiments, the processing device 110 may send early warning information via the terminal 130. In some embodiments, the terminal device 130 may include a mobile phone 130-1, a tablet computer 130-2, and a computer 130-3 (including a desktop computer and a laptop computer), or the like.

The storage device 140 may be configured to store data or information generated by other devices. In some embodiments, the storage device 140 may be configured to store an initial dataset of an energy industry chain. In some embodiments, the storage device 140 may be configured to store data and/or information processed by the processing device 110, such as a spatialized full-life-cycle carbon emission dataset and a full-life-cycle carbon emission spatial flow dataset of the energy production and consumption, or the like. The storage device 140 may include one or more storage device components, each of which may be an independent device or a part of another device. The storage device 140 may be local or implemented via a cloud platform. In some embodiments, the storage device 140 may be implemented on a cloud platform. In some embodiments, the memory may be a high-speed random access memory (RAM), and may also include non-volatile memory, such as at least one disk memory.

In some embodiments, the application scenario 100 further includes a combustion device, an exhaust gas treatment device, a monitoring device, and an unmanned vehicle cluster. More descriptions regarding the above devices may be found elsewhere in the present disclosure.

FIG. 2 is a flowchart of an exemplary process for a method for tracking spatial flow directions of carbon emissions in an energy industry chain according to some embodiments of the present disclosure. In some embodiments, the process 200 may be executed by the processing device. As illustrated in FIG. 2, the process 200 includes S1 to S3.

In steps S1, a primary energy production, a secondary energy conversion, and a final energy consumption process corresponding to spatial locations at specific sites are modeled based on a general multi-flow multi-node model to construct a spatialized full-life-cycle carbon emission accounting model for an energy production and consumption of a primary energy and a secondary energy.

The primary energy refers to energy resources that exist naturally in the environment in their original form without artificial conversion or processing, such as coal, oil, natural gas, or the like. The secondary energy refers to forms of energy obtained through conversion of primary energy, such as electricity, thermal energy, refined oil products, or the like.

The carbon emissions refer to emissions generated during the process from the primary energy production to the secondary energy conversion and then to the final energy consumption process. For example, the carbon emissions may include carbon dioxide emissions generated during mining, transportation, or combustion of coal, or the like.

The general multi-flow multi-node model refers to a general mathematical model. The general multi-flow multi-node model may be configured to describe input, output, and conversion processes of a plurality of types of flow objects (including energy flow, material flow, emission flow, or the like) among a plurality of nodes.

The spatialized full-life-cycle carbon emission accounting model refers to a specific application model constructed based on the general multi-flow multi-node model. The spatialized full-life-cycle carbon emission accounting model is used to account for embedded carbon emissions generated during the production and consumption full-life-cycle of the primary energy and the secondary energy at different nodes. The full-life-cycle includes a life cycle from the primary energy production, the secondary energy conversion, to the final energy consumption process.

The flow objects of the spatialized full-life-cycle carbon emission accounting model include product flows, embedded carbon emission flows, or the like. The product flows include production flows, transportation flows, and consumption flows in the energy industry chain. The embedded carbon emission flows are configured to characterize spatial distributions of carbon emissions corresponding to the product flows in different regions.

The energy industry chain refers to a flow process of the primary energy and the secondary energy among different regions over the full-life-cycle.

The nodes of the general multi-flow multi-node model and the spatialized full-life-cycle carbon emission accounting model are configured to represent geographical areas at a provincial scale (hereinafter referred to as provincial regions), including provinces, autonomous regions, and municipalities directly under the central government, thereby enabling a mapping from the spatial locations of the specific sites to the nodes in the models.

The specific sites refer to specific geographical locations (e.g., the provincial regions) where activities of the primary energy production, the secondary energy conversion, or the final energy consumption actually occur during the full-life-cycle of the energy industry chain. The spatial locations refer to the geographical coordinates or spatial grid location of the specific sites in the spatialized full-life-cycle carbon emission accounting model. In some embodiments, a plurality of specific sites located within the same administrative region may be treated as one node in the general multi-flow multi-node model and the spatialized full-life-cycle carbon emission accounting model.

In some embodiments, the spatialized full-life-cycle carbon emission accounting model includes product flow input-output balance equations and embedded carbon emission flow input-output balance equations; the processing device may be configured to construct the spatialized full-life-cycle carbon emission accounting model by establishing the product flow input-output balance equations and the embedded carbon emission flow input-output balance equations. In some embodiments, the processing device may be configured to construct the spatialized full-life-cycle carbon emission accounting model through steps S1.1 to S1.2.

In steps S1.1, product flow input-output balance equations are established at nodes on a provincial scale for the energy production and consumption of the primary energy and the secondary energy based on a production flow, a transportation flow, and a consumption flow in the energy industry chain.

The nodes on the provincial scale refer to nodes representing provinces, autonomous regions, or municipalities directly under the central government in the spatialized full-life-cycle carbon emission accounting model.

For an individual node, the production flow refers to an energy flow resulting from energy production within the node; the transportation flow refers to an energy flow resulting from energy transportation between the node and other nodes; and the consumption flow refers to an energy flow resulting from energy consumption or utilization within the node.

In some embodiments, the product flow input-output balance equations may be represented by the following Equation (1):

$$\{ \begin{matrix}{PP}_{ii} + {\sum }_{j , j \neq i} {tr}_{ji} = {PC}_{ii} + {\sum }_{j , j \neq i} {tr}_{ij} \\ {SP}_{ii} + {\sum }_{k , k \neq i} {ts}_{ki} = {SC}_{ii} + {\sum }_{k , k \neq i} {ts}_{ik}\end{matrix} \qquad ( 1 )$$

wherein PPᵢᵢ denotes a production flow input of the primary energy in a province i; trⱼᵢ denotes a transportation flow input of the primary energy from a province j to the province i; PCᵢᵢ denotes a consumption flow output of the primary energy in the province i; trᵢⱼ denotes a transportation flow output of the primary energy from the province i to the province j; SPᵢᵢ denotes a production flow input of the secondary energy in the province i; tsₖᵢ denotes a transportation flow input of the secondary energy from a province k to the province i; SCᵢᵢ denotes a consumption flow output of the secondary energy in the province i; and tsᵢₖ denotes a transportation flow output of the secondary energy from the province i to the province k. The production flow input of the primary energy refers to an input amount of the primary energy produced at a node and flowing into the node. The transportation flow input of the primary energy refers to an input amount of the primary energy transported from other nodes into the node. The transportation flow output of the primary energy refers to an output amount of the primary energy transported from the node to other nodes. The consumption flow output of the primary energy refers to an output amount of the primary energy consumed and utilized within the node. The meanings of the production flow input, transportation flow input, transportation flow output, and consumption flow output of the secondary energy are similar and will not be repeated herein.

In steps S1.2, embedded carbon emission flow input-output balance equations at the nodes on the provincial scale for the energy production and consumption of the primary energy and the secondary energy are established based on the product flow input-output balance equations.

The embedded carbon emission flow input-output balance equations may include a first carbon emission flow input-output balance equation and a second carbon emission flow input-output balance equation. The first carbon emission flow input-output balance equation is configured to represent the production flow, transportation flow, and consumption flow of the primary energy, as well as the embedded carbon emission intensity in the process of converting the primary energy into the secondary energy. The second carbon emission flow input-output balance equation is configured to represent the embedded carbon emission intensity corresponding to the production flow, transportation flow, and consumption flow of the secondary energy.

In some embodiments, the first carbon emission flow input-output balance equation may be expressed by the following Equation (2):

$$\{ \begin{matrix}{PP}_{ii} \cdot {a}_{i} + {\sum }_{j , j \neq i} {tr}_{ji} \cdot {b}_{j} = ( {PC}_{ii} + {\sum }_{j , j \neq i} {tr}_{ij} ) \cdot {b}_{i} \\ {SP}_{ii} \cdot \frac{{b}_{i}}{{c}_{i}} + {\sum }_{k , k \neq i} {ts}_{ki} \cdot {d}_{k} = ( {SC}_{ii} + {\sum }_{k , k \neq i} {ts}_{ik} ) \cdot {d}_{i}\end{matrix} \qquad ( 2 )$$

wherein aᵢ denotes an embedded carbon emission intensity corresponding to the production flow input of the primary energy in the province i; bⱼ denotes an embedded carbon emission intensity corresponding to the transportation flow input of the primary energy from the province j to the province i; bᵢ denotes an embedded carbon emission intensity corresponding to the consumption flow output of the primary energy in the province i; cᵢ denotes a conversion coefficient from the primary energy to the secondary energy in the province i; dₖ denotes a carbon emission intensity of the primary energy embedded in the transportation flow input of the secondary energy from the province k to the province i; and dᵢ denotes an embedded carbon emission intensity corresponding to the consumption flow output of the secondary energy in the province i.

In some embodiments, the second embedded carbon emission flow input-output balance equation may be expressed by the following Equation (3):

$${SP}_{ii} \cdot {e}_{i} + {\sum }_{k , k \neq i} {ts}_{ki} \cdot {f}_{k} = ( {SC}_{ii} + {\sum }_{k , k \neq i} {ts}_{ik} ) \cdot {f}_{i} \qquad ( 3 )$$

wherein eᵢ denotes an embedded carbon emission intensity corresponding to the production flow input of the secondary energy in the province i; fₖ denotes an embedded carbon emission intensity corresponding to the transportation flow input of the secondary energy from the province k to the province i; and fᵢ denotes an embedded carbon emission intensity corresponding to the consumption flow output of the secondary energy in the province i.

In some embodiments of the present disclosure, by establishing product flow input-output balance equations and embedded carbon emission flow input-output balance equations, a production flow input, a transportation flow input, a transportation flow output, and a consumption flow output of the primary energy and the secondary energy, as well as embedded carbon emission intensities corresponding to product flows, are determined, such that flow direction paths of the primary energy and the secondary energy within and across different geographical regions can be identified. The accuracy of the accounting results of the spatialized full-life-cycle carbon emission accounting model is improved, and the capability of identifying different types of flows is enhanced, thereby enabling strong applicability of the model in various scenarios.

In some embodiments of the present disclosure, by establishing the product flow input-output balance equations and the embedded carbon emission flow input-output balance equations, flow paths of the primary energy and the secondary energy throughout the full-life-cycle in the energy industry chain among different nodes, along with corresponding embedded carbon emission intensities, can be described. The approach helps improve the accuracy, tracking capability, and applicability of the spatialized full-life-cycle carbon emission accounting model, thereby providing technical support for tracking spatial flow directions of carbon emissions.

In steps S2, flow characteristics of carbon emissions between regions along the energy industry chain of the primary energy production—the secondary energy conversion—the final energy consumption process under different application scenarios are determined based on the spatialized full-life-cycle carbon emission accounting model of the energy production and consumption, and a full-life-cycle carbon emission spatial flow tracking model for a two-stage production and consumption from the primary energy to the secondary energy, and a one-stage production and consumption of the secondary energy is constructed.

The flow characteristics refer to characteristics related to the flows of the primary energy and the secondary energy between different regions. For example, the flow characteristics may include flow paths of the primary energy and the secondary energy between different regions, or flow paths of carbon emissions along the energy industry chain of the primary energy production—the secondary energy conversion—the final energy consumption process between different regions.

The different application scenarios refer to application scenarios of the energy industry chain under different regional, industrial structure, and energy structure conditions. For example, the application scenarios may include: energy production-oriented regions, industrial parks centered on energy conversion, and large urban agglomerations focused on terminal consumption. In different application scenarios, flow paths of the primary energy and the secondary energy between different regions vary; therefore, it is necessary to construct respective full-life-cycle carbon emission spatial flow tracking models for different application scenarios.

In some embodiments, the processing device may be configured to determine, based on the spatialized full-life-cycle carbon emission accounting model, flow characteristics of carbon emissions between different regions along the energy industry chain of the primary energy production—the secondary energy conversion—the final energy consumption process under different application scenarios. The different regions refer to different regions at the provincial scale. For example, based on Equation (2) and Equation (3), PPᵢᵢ represents the production flow input of the primary energy within province i, and aᵢ represents the embedded carbon emission intensity corresponding to the production flow input of the primary energy. Accordingly, PPᵢᵢ may reflect a flow path of the primary energy produced at node i and flowing into node i, and aᵢ may reflect a flow path of carbon emissions within node i formed by the flow of the primary energy.

The full-life-cycle carbon emission spatial flow tracking model refers to a mathematical model configured to characterize spatial flow quantities of carbon emissions between different regions. The full-life-cycle carbon emission spatial flow tracking model covers a two-stage production and consumption path including the production and consumption of the primary energy (e.g., coal mining, transportation, and consumption) and the production and consumption after the conversion of the primary energy into the secondary energy (e.g., coal-fired power generation and electricity consumption), as well as a one-stage production and consumption path including the production and consumption of the secondary energy (e.g., the consumption of externally supplied electricity). The spatial flow quantity refers to a total amount of carbon emissions transferred and flowed between different regions along the energy industry chain.

In some embodiments, the processing device may be configured to construct the full-life-cycle carbon emission spatial flow tracking model through steps S2.1 to S2.6.

In steps S2.1, in response to a determination that the primary energy production occurs in the province j, the secondary energy conversion occurs in the province i, and the final energy consumption process occurs in the province k, the full-life-cycle carbon emission spatial flow tracking model for the two-stage production and consumption from the primary energy to the secondary energy is constructed based on the following equation (4):

$${s}_{jik} = \frac{{tr}_{ji} \cdot {b}_{j}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{ts}_{ik} \cdot {d}_{i}}{( {SC}_{ii} + {\sum }_{k , k \neq i} {ts}_{ik} ) \cdot {d}_{i}} \qquad ( 4 )$$

wherein Sⱼᵢₖ denotes a spatial flow quantity of carbon emissions along the energy industry chain of the primary energy production—the secondary energy conversion—the final energy consumption process between the province j, the province i, and the province k.

In steps S2.2, in response to a determination that the primary energy production occurs in the province j, the secondary energy conversion occurs in the province i, and the final energy consumption process occurs in the province i, the full-life-cycle carbon emission spatial flow tracking model for the two-stage production and consumption from the primary energy to the secondary energy is constructed based on the following equation (5):

$${s}_{jii} = \frac{{tr}_{ji} \cdot {b}_{j}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{SC}_{ii} \cdot {d}_{i}}{( {SC}_{ii} + {\sum }_{k , k \neq i} {ts}_{ik} ) \cdot {d}_{i}} \qquad ( 5 )$$

wherein sⱼᵢᵢ denotes a spatial flow quantity of carbon emissions along the energy industry chain of the primary energy production—the secondary energy conversion—the final energy consumption process between the province j, the province i, and the province i.

In steps S2.3, in response to a determination that the primary energy production occurs in the province i, the secondary energy conversion occurs in the province i, and the final energy consumption process occurs in the province k, the full-life-cycle carbon emission spatial flow tracking model for the two-stage production and consumption from the primary energy to the secondary energy is constructed based on the following equation (6):

$${s}_{iik} = \frac{{PP}_{ii} \cdot {a}_{i}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{ts}_{ik} \cdot {d}_{i}}{( {SC}_{ii} + {\sum }_{k , k \neq i} {ts}_{ik} ) \cdot {d}_{i}} \qquad ( 6 )$$

wherein Sᵢᵢₖ denotes a spatial flow quantity of carbon emissions along the energy industry chain of the primary energy production—the secondary energy conversion—the final energy consumption process between the province i, the province i, and the province k.

In steps S2.4, in response to a determination that the primary energy production occurs in the province i, the secondary energy conversion occurs in the province i, and the final energy consumption process occurs in the province i, the full-life-cycle carbon emission spatial flow tracking model for the two-stage production and consumption from the primary energy to the secondary energy is constructed based on the following equation (7):

$${s}_{iii} = \frac{{PP}_{ii} \cdot {a}_{i}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{SC}_{ii} \cdot {d}_{i}}{( {SC}_{ii} + {\sum }_{k , k \neq i} {ts}_{ik} ) \cdot {d}_{i}} \qquad ( 7 )$$

wherein Sᵢᵢᵢ denotes a spatial flow quantity of carbon emissions along the energy industry chain of the primary energy production—the secondary energy conversion—the final energy consumption process between the province i, the province i, and the province i.

In steps S2.5, in response to a determination that the secondary energy conversion occurs in the province k and the final energy consumption process occurs in the province i, the full-life-cycle carbon emission spatial flow tracking model for the one-stage production and consumption of the secondary energy is constructed based on the following equation (8):

$${t}_{ki} = \frac{{ts}_{ki} \cdot {f}_{k}}{{SP}_{ii} \cdot {e}_{i} + {\sum }_{k , k \neq i} {ts}_{ki} \cdot {f}_{k}} \cdot {SC}_{ii} \cdot {f}_{i} \qquad ( 8 )$$

wherein tₖᵢ denotes a spatial flow quantity of carbon emissions along an energy industry chain of the secondary energy conversion—the final energy consumption process between the province k and the province i.

In steps S2.6, in response to a determination that the secondary energy conversion occurs in the province i and the final energy consumption process occurs in the province i, the full-life-cycle carbon emission spatial flow tracking model for the one-stage production and consumption of the secondary energy is constructed based on the following equation (9):

$${t}_{ii} = \frac{{SP}_{ii} \cdot {e}_{i}}{{SP}_{ii} \cdot {e}_{i} + {\sum }_{k , k \neq i} {ts}_{ki} \cdot {f}_{k}} \cdot {SC}_{ii} \cdot {f}_{i} \qquad ( 9 )$$

wherein tᵢᵢ denotes a spatial flow quantity of carbon emissions along the energy industry chain of the secondary energy conversion—the final energy consumption process between the province i and the province i.

In some embodiments of the present disclosure, by constructing the full-life-cycle carbon emission spatial flow tracking model for the two-stage production and consumption from the primary energy to the secondary energy and the one-stage production and consumption of the secondary energy, the flow paths and spatial flow quantities of carbon emissions between regions along the energy industry chain of the primary energy production—the secondary energy conversion—the final energy consumption process may be determined. The cross-regional carbon emissions from multiple stages such as coal mining, coal-fired power generation, and terminal electricity consumption may be effectively tracked, which facilitates subsequent governance of the carbon emissions.

In steps S3, based on an accounting object, an initial dataset of the energy industry chain is determined, the initial dataset of the energy industry chain is substituted into the spatialized full-life-cycle carbon emission accounting model for the energy production and consumption of the primary energy and the secondary energy, and into the full-life-cycle carbon emission spatial flow tracking model for the two-stage production and consumption from the primary energy to the secondary energy and the one-stage production and consumption of the secondary energy, to determine a spatialized full-life-cycle carbon emission dataset and a full-life-cycle carbon emission spatial flow dataset of the energy production and consumption that meet quality evaluation requirements.

The accounting object refers to the object whose carbon emissions need to be accounted. The accounting object defines the geographical region (e.g., a certain province or city, hereinafter referred to as the accounting region), energy product (the primary energy and/or the secondary energy, such as coal or electricity), segments of the energy industry chain, accounting time, and the like, for which carbon emissions are to be accounted. For example, the accounting object may be the full-life-cycle carbon emissions of coal in the energy industry chain of Province A in the year 2024.

The initial dataset of the energy industry chain refers to a collection of raw data associated with the energy industry chain in the process of the primary energy production—the secondary energy conversion—the final energy consumption process. The initial dataset of the energy industry chain includes data related to the production, consumption, and transportation of the primary energy and the secondary energy in the accounting object. For example, the initial dataset of the energy industry chain may include data relating to the coal production, electricity input and output, and electricity consumption within the accounting object during a certain year.

In some embodiments, the spatialized full-life-cycle carbon emission dataset is generated based on a first accounting result that meets second quality evaluation requirements, and therefore the dataset also meets the second quality evaluation requirements. The full-life-cycle carbon emission spatial flow dataset is generated based on a second accounting result that meets third quality evaluation requirements, and therefore the dataset also meets the third quality evaluation requirements. More descriptions about the quality evaluation requirements and the accounting result may be found in other contents of the present disclosure.

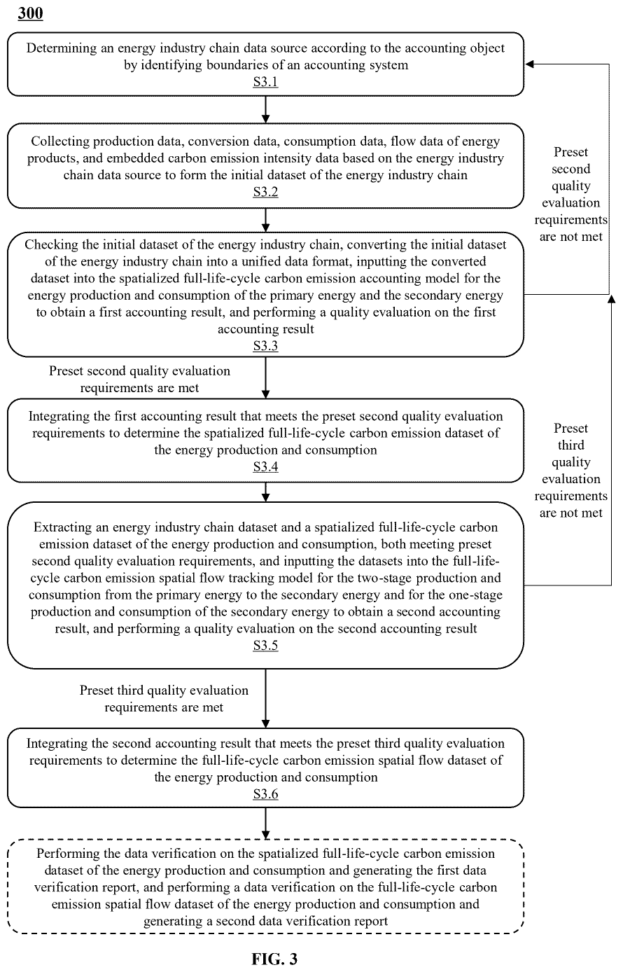

FIG. 3 is a flowchart of an exemplary process for determining a spatialized full-life-cycle carbon emission dataset and a full-life-cycle carbon emission spatial flow dataset according to some embodiments of the present disclosure. As illustrated in FIG. 3, the processing device may be configured to determine the initial dataset of the energy industry chain through steps S3.1 to S3.2, and determine the spatialized full-life-cycle carbon emission dataset and the full-life-cycle carbon emission spatial flow dataset through steps S3.3 to S3.6.

In steps S3.1, an energy industry chain data source is determined according to the accounting object by identifying boundaries of an accounting system.

The boundaries of an accounting system refer to boundary conditions for carbon emission accounting. The boundaries of the accounting system include a spatial boundary (e.g., a geographic region range of the accounting object), a temporal boundary (e.g., a single year or multiple years), an energy product boundary (e.g., the primary energy or the secondary energy), an industry chain stage boundary (e.g., the primary energy production—the secondary energy conversion—the final energy consumption process), or the like. The energy product refers to an energy form involved in the energy industry chain, including the primary energy and the secondary energy.

In some embodiments, the energy industry chain data source may be determined by the processing device based on the accounting object through identifying the boundaries of the accounting system. Specifically, a region and a time range corresponding to the accounting object may be determined as the spatial boundary and the temporal boundary; an energy product involved in the accounting object may be used as the energy product boundary; and the primary energy production stage, the secondary energy conversion stage, and the final energy consumption stage involved in the accounting object may be used as the industry chain stage boundary.

The energy industry chain data source refers to a source for acquiring data related to the energy industry chain. The energy industry chain data source includes but is not limited to national statistical yearbooks, local energy statistical yearbooks, energy regulatory system platforms, and other authoritative and representative data platforms.

In some embodiments, the energy industry chain data source may be determined by the processing device based on the boundaries of the accounting system. For example, if the temporal boundary is 2021 and the spatial boundary is Shanxi Province, the energy industry chain data source is a 2021 energy statistical yearbook of Shanxi Province.

In steps S3.2, production data, conversion data, consumption data, flow data of energy products, and embedded carbon emission intensity data are collected based on the energy industry chain data source to form the initial dataset of the energy industry chain.

In some embodiments, the production data, the conversion data, the consumption data, the flow data, and the embedded carbon emission intensity data may be collected through field investigations, national statistical yearbooks, local energy statistical yearbooks, or other data sources.

In some embodiments, the processing device may be configured to determine the spatialized full-life-cycle carbon emission dataset and the full-life-cycle carbon emission spatial flow dataset through steps S3.3 to S3.6.

The spatialized full-life-cycle carbon emission dataset refers to a dataset related to the carbon emissions formed during the full-life-cycle from the primary energy production to the secondary energy conversion and then to the final energy consumption. For example, the spatialized full-life-cycle carbon emission dataset includes a production flow input, a transportation flow input/output, and a consumption flow input/output of the primary energy and the secondary energy, as well as carbon emission factors of respective regions. For example, the carbon emission factors may include a coal consumption CO₂ emission factor, a two-stage coal power consumption CO₂ emission factor, and a one-stage coal power consumption CO₂ emission factor, or the like.

The full-life-cycle carbon emission spatial flow dataset refers to a dataset related to spatial flows of carbon emissions between different regions, formed during the full-life-cycle from the primary energy production to the secondary energy conversion and then to final energy consumption.

In steps S3.3, the initial dataset of the energy industry chain is checked, the initial dataset of the energy industry chain is converted into a unified data format, and the converted dataset is input into the spatialized full-life-cycle carbon emission accounting model for the energy production and consumption of the primary energy and the secondary energy to obtain a first accounting result; a quality evaluation is performed on the first accounting result; in response to determining that the first accounting result does not meet preset second quality evaluation requirements, the S3.1 is proceeded to re-determine the energy industry chain data source; otherwise, the S3.4 is proceeded to.

In some embodiments, the processing device may perform an integrity and consistency check on the initial dataset of the energy industry chain to determine whether the initial dataset meets first quality evaluation requirements. In response to a determination that the initial dataset passes the integrity and consistency check, the initial dataset meets the first quality evaluation requirements; otherwise, the initial dataset does not meet the first quality evaluation requirements. In response to a determination that the initial dataset of the energy industry chain does not meet the first quality evaluation requirements, the S3.1 is re-executed to re-determine the energy industry chain data source. In response to a determination that the initial dataset meets the first quality evaluation requirements, data in the initial dataset is converted into the unified data format. For example, if data in the initial dataset of the energy industry chain uses different measurement units (such as tons of standard coal or kilowatt-hours) or different time units (such as annual data and quarterly data), a unified conversion may be performed by the processing device to ensure that data input into the spatialized full-life-cycle carbon emission accounting model has a consistent data format.

The processing device may further substitute the initial dataset with the unified format into the spatialized full-life-cycle carbon emission accounting model, and determine the first accounting result based on Equations (1) to (3). More details about Equations (1) to (3) may be found in steps S1.1 to S1.2 and related descriptions.

In some embodiments, the quality evaluation may be performed on the first accounting result by the processing device based on the second quality evaluation requirements. In response to a determination that the first accounting result does not meet the second quality evaluation requirements, the S3.1 is re-executed to re-determine the energy industry chain data source; in response to a determination that the first accounting result meets the second quality evaluation requirements, the initial dataset with the unified format is used as the energy industry chain dataset, and the S3.4 is performed. The second quality evaluation requirements may be preset based on prior knowledge.

In some embodiments, the second quality evaluation requirements may include a requirement for a first uncertainty in the first accounting result. Specifically, the second quality evaluation requirements may specify that the first uncertainty of the first accounting result shall not exceed a preset threshold, such as 10%. In response to determining that the first uncertainty exceeds the preset threshold, the first accounting result does not to meet the second quality evaluation requirements. The first uncertainty refers to a confidence level of the first accounting result. The first uncertainty may reflect a probability of deviation of the first accounting result from a theoretical embedded carbon emission level, and the first uncertainty may be quantified through statistical analysis or an error propagation method.

In steps S3.4, the first accounting result that meets the preset second quality evaluation requirements is integrated to determine the spatialized full-life-cycle carbon emission dataset of the energy production and consumption.

In some embodiments, an integration operation may be performed, by the processing device, on the first accounting result that meets the second quality evaluation requirements, and the spatialized full-life-cycle carbon emission dataset of the energy production and consumption may be constructed based on the integrated first accounting result. The integration operation may include classifying and aggregating data corresponding to different regions, the energy products, the energy industry chains, and time units in the first accounting result, and performing data normalization processing. For example, carbon emission data from coal mining, coal-to-electricity conversion, and coal consumption in a plurality of provinces may be classified and organized according to region names, energy types, emission stages, and emission factors, respectively, to form a unified-format spatialized full-life-cycle carbon emission dataset.

In some embodiments, the processing device may perform the data verification on the spatialized full-life-cycle carbon emission dataset of the energy production and consumption and generate a first data verification report. More details about the first data verification report may be found in other contents of the present disclosure.

In steps S3.5, an energy industry chain dataset and a spatialized full-life-cycle carbon emission dataset of the energy production and consumption, both meeting preset second quality evaluation requirements, are extracted and inputted into the full-life-cycle carbon emission spatial flow tracking model for the two-stage production and consumption from the primary energy to the secondary energy and for the one-stage production and consumption of the secondary energy to obtain a second accounting result; a quality evaluation is performed on the second accounting result; in response to determining that the second accounting result does not meet preset third quality evaluation requirements, the S3.1 is proceeded to re-determine the energy industry chain data source; otherwise, the S3.6 is proceeded to.

In some embodiments, a portion of data is randomly extracted by the processing device from the energy industry chain dataset and the spatialized full-life-cycle carbon emission dataset, and input into the full-life-cycle carbon emission spatial flow tracking model to determine the second accounting result, and the quality evaluation is performed on the second accounting result. In response to determining that the second accounting result does not meet preset third quality evaluation requirements, the boundaries of the accounting system are re-identified based on the accounting object, and the energy industry chain data source is re-determined; in response to determining that the second accounting result meets preset third quality evaluation requirements, the S3.6 is proceeded to. The preset third quality evaluation requirements may be set in advance based on prior knowledge. Since the energy industry chain dataset is determined based on the initial dataset that meets the first quality evaluation requirements, the energy industry chain dataset may also be regarded as meeting the first quality evaluation requirements.

In some embodiments, the third quality evaluation requirements may include a requirement for a second uncertainty in a second accounting result. Specifically, the third quality evaluation requirements may specify that the second uncertainty of the second accounting result shall not exceed a preset threshold, such as 10%. In response to determining that the second uncertainty exceeds the preset threshold, the second accounting result does not meet the third quality evaluation requirements. The second uncertainty is similar to the first uncertainty, and details thereof are not repeated herein.

In steps S3.6, the second accounting result that meets the preset third quality evaluation requirements is integrated to determine the full-life-cycle carbon emission spatial flow dataset of the energy production and consumption.

In some embodiments, the processing device may perform an integration operation on the second accounting result that meets the third quality evaluation requirements, and construct the full-life-cycle carbon emission spatial flow dataset of the energy production and consumption based on the integrated second accounting result. The integration operation may include classification and aggregation of the second accounting result. For example, the carbon emissions involving multiple time dimensions (e.g., annual or quarterly) may be converted into unified units and transformed into a consistent format to form a standardized full-life-cycle carbon emission spatial flow dataset.

In some embodiments, the processing device may perform a data verification on the full-life-cycle carbon emission spatial flow dataset of the energy production and consumption, and generate a second data verification report. More information about the second data verification report may be found in other contents of the present disclosure.

In some embodiments of the present disclosure, by collecting the energy industry chain data covering multiple stages such as production, conversion, consumption, and flow, and integrating the embedded carbon emission intensity data, the standardized initial dataset of the energy industry chain is formed, which is capable of providing data support for the spatialized full-life-cycle carbon emission accounting model and the full-life-cycle carbon emission spatial flow tracking model. By performing rigorous screening and integration on the first accounting result and the second accounting result based on preset second quality evaluation requirements and third quality evaluation requirements, low-quality or incomplete data can be effectively eliminated, thereby improving the accuracy and reliability of the first accounting result and the second accounting result.

In some embodiments of the present disclosure, by constructing the spatialized full-life-cycle carbon emission accounting model and the full-life-cycle carbon emission spatial flow tracking model, spatial dynamic tracking and evaluation of carbon emissions in the entire process of the primary energy production, the secondary energy conversion, and the final energy consumption are achieved. Flow paths and spatial flow quantities of carbon emissions across different regions can be effectively identified, and attribution regions of carbon emissions can be accurately defined. By constructing the spatialized full-life-cycle carbon emission dataset and the full-life-cycle carbon emission spatial flow dataset, the embedded carbon emissions in different stages of the energy industry chain can be comprehensively captured from both temporal and spatial dimensions, which helps identify regions with high emission intensity and accurately track the flow paths of the embedded carbon emissions across different regions.

It should be noted that the above description related to the process 200 is merely for illustration and explanation, and does not limit the scope of applicability of the present disclosure. Various modifications and changes to the process may be made by those skilled in the art in light of the present disclosure. However, these modifications and changes still fall within the scope of the present disclosure.

To further illustrate the method for tracking spatial flow directions of carbon emissions in an energy industry chain provided by the present disclosure, the following description is made in conjunction with an embodiment. Taking the coal industry in China as an example, a primary energy production, a secondary energy conversion, and a final energy consumption process correspond to a coal mining, a coal-fired power generation, and a coal consumption process, respectively. In the present embodiment, a spatial scope of carbon emission accounting is at a provincial scale. Coal production data, coal inflow data, coal consumption data, coal outflow data, and coal mining carbon emission factor data of each province are collected through field investigation; coal power production data, coal power inflow data, coal power consumption data, coal power outflow data, and carbon emission factor data of coal-fired power generation are acquired based on the “China Electric Power Yearbook”, so as to construct the initial dataset of the energy industry chain. The initial dataset of the energy industry chain is substituted into the spatialized full-life-cycle carbon emission accounting model for the energy production and consumption of the primary energy (coal) and the secondary energy (coal power), and into the full-life-cycle carbon emission spatial flow tracking model for the two-stage production and consumption from the primary energy (coal) to the secondary energy (coal power) and for the one-stage production and consumption of the secondary energy (coal power), to determine a spatialized full-life-cycle carbon emission dataset of coal-based energy product production and consumption and a full-life-cycle carbon emission spatial flow dataset of coal-based energy product production and consumption. Taking carbon dioxide emissions as an example, a first accounting result and a second accounting result are shown in Tables 1-4.

TABLE 1
Provincial Coal Balance Sheet

| | | | | | Coal |
|---|---|---|---|---|---|
| | | | | | production |
| | | | | Coal | CO2 |
| | Coal | Coal | Coal | consump- | emission |
| | Production | inflow | outflow | tion | factor |
| | (tons) | (tons) | (tons) | (tons) | (tons/ton) |
| Anhui | 11177 | 7230.96 | 1749.01 | 16658.95 | 0.0343 |
| Beijing | 0 | 1587.67 | 0 | 1587.67 | 0.0238 |
| Fujian | 445 | 10485.57 | 0 | 10930.57 | 0.0252 |
| Gansu | 5414 | 4631.66 | 1296.13 | 8749.53 | 0.0334 |
| Guangdong | 0 | 20663.07 | 0.06 | 20663.01 | 0 |
| Guangxi | 381 | 5228.94 | 0 | 5609.94 | 0.0330 |
| Guizhou | 13069 | 1071.94 | 2709.44 | 11431.5 | 0.0307 |
| Hainan | 0 | 930.85 | 0 | 930.85 | 0 |
| Hebei | 4706 | 33738.68 | 1686.86 | 36757.82 | 0.0332 |
| Henan | 9804 | 10137.65 | 2392.05 | 17549.6 | 0.0315 |
| Heilongjiang | 6955 | 5685.79 | 1107.32 | 11533.47 | 0.0282 |
| Province | | | | | |
| Hubei | 73 | 10270.77 | 0 | 10343.77 | 0.0256 |
| Hunan | 800 | 8997.92 | 21.41 | 9776.51 | 0.0322 |
| Jilin | 971 | 7082.99 | 43.16 | 8010.83 | 0.0322 |
| Jiangsu | 964 | 25937.74 | 288.36 | 26613.38 | 0.0347 |
| Jiangxi | 216 | 4515.27 | 54.59 | 4676.68 | 0.0273 |
| Liaoning | 3158 | 11368.33 | 33.96 | 14492.37 | 0.0328 |
| Inner | 121354 | 4088.5 | 82384.98 | 43057.52 | 0.0258 |
| Mongolia | | | | | |
| Ningxia | 9479 | 1527.07 | 718.24 | 10287.83 | 0.0339 |
| Qinghai | 936 | 992.25 | 0 | 1928.25 | 0.0268 |
| Shandong | 8753 | 28548.54 | 1701.32 | 35600.22 | 0.0331 |
| Shanxi | 132009 | 9127.75 | 75223.33 | 65913.42 | 0.0334 |
| Shaanxi | 74876 | 1584.38 | 51493.48 | 24966.9 | 0.0340 |
| Shanghai | 0 | 5934.61 | 0 | 5934.61 | 0 |
| Sichuan | 2269 | 3355.31 | 130.27 | 5494.04 | 0.0292 |
| Tianjin | 0 | 4061.29 | 0 | 4061.29 | 0 |
| Foreign | 376200 | 272.87 | 26279.68 | 350193.19 | 0 |
| country | | | | | |
| Tibet | 0 | 0.18 | 0 | 0.18 | 0 |
| Xinjiang | 41305 | 301.41 | 3938.94 | 37667.47 | 0.0238 |
| Yunnan | 6741 | 1150.44 | 608.58 | 7282.86 | 0.0254 |
| Zhejiang | 0 | 19540.44 | 0.23 | 19540.21 | 0 |
| Chongqing | 0 | 3810.56 | 0 | 3810.56 | 0.0301 |

TABLE 2
Provincial Coal Power Balance Sheet

| | | | | Coal and | |
|---|---|---|---|---|---|
| | Coal and | Coal and | Coal and | electricity | Coal |
| | electricity | power | electricity | consump- | power |
| | production | inflow | outflow | tion | produc- |
| | (billions | (billions | (billions | (billions | tion CO2 |
| | of | of | of | of | emission |
| | kilowatt- | kilowatt- | kilowatt- | kilowatt- | factor |
| | hours) | hours) | hours) | hours) | (g/kWh) |
| Anhui | 2646 | 475.50 | 711.13 | 2410.37 | 785.89 |
| Beijing | 9 | 847.68 | 0.88 | 855.80 | 574.65 |
| Fujian | 1399 | 2.86 | 81.73 | 1320.12 | 813.55 |
| Gansu | 1049 | 209.59 | 449.25 | 809.34 | 832.44 |
| Guangdong | 3265 | 534.41 | 81.51 | 3717.89 | 777.37 |
| Guangxi | 827 | 38.04 | 51.39 | 813.64 | 818.61 |
| Guizhou | 1360 | 6.82 | 344.13 | 1022.69 | 860.64 |
| Hainan | 150 | 1.55 | 0.74 | 150.81 | 766.20 |
| Hebei | 2084 | 1645.96 | 500.98 | 3228.98 | 759.55 |
| Henan | 2466 | 417.53 | 65.83 | 2817.70 | 811.96 |
| Heilongjiang | 721 | 96.26 | 116.80 | 700.46 | 839.63 |
| Province | | | | | |
| Hubei | 1405 | 197.55 | 343.15 | 1259.40 | 777.37 |
| Hunan | 876 | 313.19 | 64.18 | 1125.01 | 825.53 |
| Jilin | 596 | 102.92 | 193.10 | 505.81 | 774.18 |
| Jiangsu | 3882 | 1013.57 | 158.17 | 4737.40 | 777.64 |
| Jiangxi | 1140 | 56.04 | 47.79 | 1148.25 | 786.95 |
| Liaoning | 1141 | 453.55 | 123.33 | 1471.22 | 799.99 |
| Inner | 5019 | 223.09 | 2020.54 | 3221.55 | 825.26 |
| Mongolia | | | | | |
| Ningxia | 1535 | 70.54 | 705.44 | 900.10 | 832.18 |
| Qinghai | 151 | 91.82 | 52.19 | 190.64 | 864.90 |
| Shandong | 4713 | 625.73 | 1.28 | 5337.45 | 767.00 |
| Shanxi | 3229 | 321.23 | 1185.79 | 2364.45 | 830.05 |
| Shaanxi | 2221 | 171.06 | 987.37 | 1404.68 | 847.34 |
| Shanghai | 702 | 373.76 | 35.41 | 1040.36 | 796.26 |
| Sichuan | 577 | 143.34 | 254.66 | 465.68 | 819.67 |
| Tianjin | 529 | 243.60 | 165.43 | 607.17 | 764.87 |
| Foreign | 52379 | 91.86 | 16.33 | 52454.53 | 754.76 |
| country | | | | | |
| Tibet | 0 | 2.97 | 0.46 | 2.51 | 754.76 |
| Xinjiang | 3457 | 4.24 | 900.64 | 2560.60 | 833.77 |
| Yunnan | 390 | 38.53 | 182.30 | 246.24 | 883.52 |
| Zhejiang | 2619 | 1021.91 | 100.23 | 3540.68 | 782.16 |
| Chongqing | 635 | 142.04 | 36.56 | 740.48 | 812.76 |

TABLE 3
Spatialized Full-Life-Cycle Carbon Emission Dataset of the
Production and Consumption of Coal-Based Energy Products

| | | CO2 emission | CO2 emission |
|---|---|---|---|
| | Coal consumption | factor for two- | factor for one- |
| | CO2 emission | stage coal power | stage coal power |
| | factor | consumption | consumption |
| | (tons/ton) | (g/kWh) | (g/kWh) |
| Anhui | 0.0327 | 12.403 | 793.068 |
| Beijing | 0.0313 | 12.260 | 796.281 |
| Fujian | 0.0112 | 4.594 | 813.504 |
| Gansu | 0.0304 | 12.368 | 832.984 |
| Guangdong | 0.0204 | 8.526 | 787.158 |
| Guangxi | 0.0245 | 10.101 | 819.424 |
| Guizhou | 0.0308 | 12.905 | 860.452 |
| Hainan | 0.0078 | 3.014 | 766.885 |
| Hebei | 0.0308 | 11.993 | 791.646 |
| Henan | 0.0322 | 12.651 | 815.338 |
| Heilongjiang | 0.0263 | 10.589 | 825.842 |
| Province | | | |
| Hubei | 0.0313 | 12.310 | 784.142 |
| Hunan | 0.0298 | 12.317 | 824.606 |
| Jilin | 0.0245 | 9.482 | 781.735 |
| Jiangsu | 0.0288 | 11.454 | 785.997 |
| Jiangxi | 0.0315 | 12.477 | 788.049 |
| Liaoning | 0.0273 | 10.613 | 804.455 |
| Inner | 0.0254 | 10.294 | 824.553 |
| Mongolia | | | |
| Ningxia | 0.0333 | 13.383 | 832.119 |
| Qinghai | 0.0294 | 12.475 | 852.843 |
| Shandong | 0.0308 | 11.649 | 773.950 |
| Shanxi | 0.0334 | 13.494 | 830.442 |
| Shaanxi | 0.0338 | 14.009 | 846.234 |
| Shanghai | 0.0229 | 10.009 | 794.246 |
| Sichuan | 0.0308 | 12.687 | 825.069 |
| Tianjin | 0.0306 | 11.882 | 784.905 |
| Foreign | 0 | 0.024 | 1.388 |
| country | | | |
| Tibet | 0.0304 | 12.554 | 842.410 |
| Xinjiang | 0.0237 | 9.616 | 833.773 |
| Yunnan | 0.0261 | 11.250 | 869.747 |
| Zhejiang | 0.0262 | 10.780 | 790.202 |
| Chongqing | 0.0312 | 12.476 | 814.117 |

TABLE 4
Full-Life-Cycle Carbon Emission Spatial Flow Dataset of the
Production and Consumption of Coal-Based Energy Products

| Production | Transformation | Consumption | sⱼᵢₖ | sⱼᵢᵢ | sᵢᵢₖ | sᵢᵢᵢ | tₖᵢ | tᵢᵢ |
|---|---|---|---|---|---|---|---|---|
| i; j; k | i; j; k | i; j; k | (tons) | (tons) | (tons) | (tons) | (tons) | (tons) |
| Shanxi | Anhui | Beijing | 16.00 | / | / | / | / | / |
| Shanxi | Anhui | Zhejiang | 7.52 | / | / | / | / | / |
| Inner | Anhui | Beijing | 6.87 | / | / | / | / | / |
| Mongolia | | | | | | | | |
| Shanxi | Tianjin | Beijing | 6.60 | / | / | / | / | / |
| Inner | Anhui | Zhejiang | 6.42 | / | / | / | / | / |
| Mongolia | | | | | | | | |
| Inner | Jilin | Inner | 6.03 | / | / | / | / | / |
| Mongolia | | Mongolia | | | | | | |
| Inner | Jilin | Liaoning | 5.72 | / | / | / | / | / |
| Mongolia | | | | | | | | |
| Shanxi | Hubei | Shanghai | 5.06 | / | / | / | / | / |
| Inner | Liaoning | Anhui | 4.40 | / | / | / | / | / |
| Mongolia | | | | | | | | |
| Shaanxi | Ningxia | Zhejiang | 3.97 | / | / | / | / | / |
| (sth. or sb) | (sth. or sb) | (sth. or sb) | 186.50 | / | / | / | / | / |
| else | else | else | | | | | | |
| Shanxi | Shandong | Shandong | / | 236.94 | / | / | / | / |
| Inner | Jiangsu | Jiangsu | / | 136.18 | / | / | / | / |
| Mongolia | | | | | | | | |
| Shaanxi | Jiangsu | Jiangsu | / | 124.59 | / | / | / | / |
| Shanxi | Jiangsu | Jiangsu | / | 120.16 | / | / | / | / |
| Shanxi | Anhui | Anhui | / | 107.64 | / | / | / | / |
| Inner | Zhejiang | Zhejiang | / | 99.95 | / | / | / | / |
| Mongolia | | | | | | | | |
| Inner | Shandong | Shandong | / | 96.63 | / | / | / | / |
| Mongolia | | | | | | | | |
| Shaanxi | Guangdong | Guangdong | / | 89.79 | / | / | / | / |
| Shanxi | Henan | Henan | / | 88.42 | / | / | / | / |
| Shanxi | Zhejiang | Zhejiang | / | 84.75 | / | / | / | / |
| (sth. or sb) | (sth. or sb) | (sth. or sb) | / | 1538.55 | / | / | / | / |
| else | else | else | | | | | | |
| Shaanxi | Shaanxi | Anhui | / | / | 76.84 | / | / | / |
| Inner | Inner | Anhui | / | / | 51.61 | / | / | / |
| Mongolia | Mongolia | | | | | | | |
| Inner | Inner | Shandong | / | / | 46.29 | / | / | / |
| Mongolia | Mongolia | | | | | | | |
| Shanxi | Shanxi | Anhui | / | / | 45.94 | / | / | / |
| Xinjiang | Xinjiang | Anhui | / | / | 44.84 | / | / | / |
| Ningxia | Ningxia | Zhejiang | / | / | 44.41 | / | / | / |
| Inner | Inner | Liaoning | / | / | 34.74 | / | / | / |
| Mongolia | Mongolia | | | | | | | |
| Anhui | Anhui | Zhejiang | / | / | 33.47 | / | / | / |
| Shanxi | Shanxi | Jiangsu | / | / | 33.27 | / | / | / |
| Xinjiang | Xinjiang | Henan | / | / | 31.24 | / | / | / |
| (sth. or sb) | (sth. or sb) | (sth. or sb) | / | / | 350.84 | / | / | / |
| else | else | else | | | | | | |
| Anhui | Anhui | Anhui | / | / | / | 168.24 | / | / |
| Beijing | Beijing | Beijing | / | / | / | 0 | / | / |
| Fujian | Fujian | Fujian | / | / | / | 5.54 | / | / |
| Gansu | Gansu | Gansu | / | / | / | 50.21 | / | / |
| Guangdong | Guangdong | Guangdong | / | / | / | 0 | / | / |
| Guangxi | Guangxi | Guangxi | / | / | / | 7.11 | / | / |
| Guizhou | Guizhou | Guizhou | / | / | / | 121.12 | / | / |
| Hainan | Hainan | Hainan | / | / | / | 0 | / | / |
| Anhui | Anhui | Anhui | / | / | / | 27.75 | / | / |
| Henan | Henan | Henan | / | / | / | 151.27 | / | / |
| Heilongjiang | Heilongjiang | Heilongjiang | / | / | / | 39.42 | / | / |
| Province | Province | Province | | | | | | |
| Hubei | Hubei | Hubei | / | / | / | 0.77 | / | / |
| Hunan | Hunan | Hunan | / | / | / | 8.98 | / | / |
| Jilin | Jilin | Jilin | / | / | / | 6.35 | / | / |
| Jiangsu | Jiangsu | Jiangsu | / | / | / | 18.26 | / | / |
| Jiangxi | Jiangxi | Jiangxi | / | / | / | 5.40 | / | / |
| Liaoning | Liaoning | Liaoning | / | / | / | 29.74 | / | / |
| Inner | Inner | Inner | / | / | / | 311.09 | / | / |
| Mongolia | Mongolia | Mongolia | | | | | | |
| Ningxia | Ningxia | Ningxia | / | / | / | 101.53 | / | / |
| Qinghai | Qinghai | Qinghai | / | / | / | 6.57 | / | / |
| Shandong | Shandong | Shandong | / | / | / | 139.56 | / | / |
| Shanxi | Shanxi | Shanxi | / | / | / | 274.89 | / | / |
| Shaanxi | Shaanxi | Shaanxi | / | / | / | 181.52 | / | / |
| Shanghai | Shanghai | Shanghai | / | / | / | 0 | / | / |
| Sichuan | Sichuan | Sichuan | / | / | / | 17.99 | / | / |
| Tianjin | Tianjin | Tianjin | / | / | / | 0 | / | / |
| aliens | aliens | aliens | / | / | / | 0 | / | / |
| Tibet | Tibet | Tibet | / | / | / | 0 | / | / |
| Xinjiang | Xinjiang | Xinjiang | / | / | / | 245.26 | / | / |
| Yunnan | Yunnan | Yunnan | / | / | / | 20.91 | / | / |
| Zhejiang | Zhejiang | Zhejiang | / | / | / | 0 | / | / |
| Chongqing | Chongqing | Chongqing | / | / | / | 0 | / | / |
| | Shaanxi | Anhui | / | / | / | / | 4356.22 | / |
| | Inner | Shandong | / | / | / | / | 3952.01 | / |
| | Mongolia | | | | | | | |
| | Inner | Anhui | / | / | / | / | 3815.16 | / |
| | Mongolia | | | | | | | |
| | Anhui | Beijing | / | / | / | / | 3796.53 | / |
| | Anhui | Zhejiang | / | / | / | / | 3698.58 | / |
| | Ningxia | Zhejiang | / | / | / | / | 3186.08 | / |
| | Xinjiang | Anhui | / | / | / | / | 3014.12 | / |
| | Shanxi | Anhui | / | / | / | / | 2840.63 | / |
| | Inner | Liaoning | / | / | / | / | 2737.04 | / |
| | Mongolia | | | | | | | |
| | Xinjiang | Henan | / | / | / | / | 2656.98 | / |
| | (sth. or sb) | (sth. or sb) | / | / | / | / | 38938.09 | / |
| | else | else | | | | | | |
| | Anhui | Anhui | / | / | / | / | / | 16057.21 |
| | Beijing | Beijing | / | / | / | / | / | 51.67 |
| | Fujian | Fujian | / | / | / | / | / | 10718.02 |
| | Gansu | Gansu | / | / | / | / | / | 5615.34 |
| | Guangdong | Guangdong | / | / | / | / | / | 24836.68 |
| | Guangxi | Guangxi | / | / | / | / | / | 6367.68 |
| | Guizhou | Guizhou | / | / | / | / | / | 8757.81 |
| | Hainan | Hainan | / | / | / | / | / | 1143.69 |
| | Anhui | Anhui | / | / | / | / | / | 13702.94 |
| | Henan | Henan | / | / | / | / | / | 19565.76 |
| | Heilongjiang | Heilongjiang | / | / | / | / | / | 5188.53 |
| | Province | Province | | | | | | |
| | Hubei | Hubei | / | / | / | / | / | 8583.37 |
| | Hunan | Hunan | / | / | / | / | / | 6841.30 |
| | Jilin | Jilin | / | / | / | / | / | 3339.27 |
| | Jiangsu | Jiangsu | / | / | / | / | / | 29212.59 |
| | Jiangxi | Jiangxi | / | / | / | / | / | 8612.78 |
| | Liaoning | Liaoning | / | / | / | / | / | 8421.85 |
| | Inner | Inner | / | / | / | / | / | 25454.72 |
| | Mongolia | Mongolia | | | | | | |
| | Ningxia | Ningxia | / | / | / | / | / | 7161.33 |
| | Qinghai | Qinghai | / | / | / | / | / | 1025.32 |
| | Shandong | Shandong | / | / | / | / | / | 36139.88 |
| | Shanxi | Shanxi | / | / | / | / | / | 17850.25 |
| | Shaanxi | Shaanxi | / | / | / | / | / | 11051.32 |
| | Shanghai | Shanghai | / | / | / | / | / | 5405.78 |
| | Sichuan | Sichuan | / | / | / | / | / | 3057.48 |
| | Tianjin | Tianjin | / | / | / | / | / | 3179.81 |
| | Foreign | Foreign | / | / | / | / | / | 0 |
| | country | country | | | | | | |
| | Tibet | Tibet | / | / | / | / | / | 0 |
| | Xinjiang | Xinjiang | / | / | / | / | / | 21323.47 |
| | Yunnan | Yunnan | / | / | / | / | / | 1979.94 |
| | Zhejiang | Zhejiang | / | / | / | / | / | 19920.86 |
| | Chongqing | Chongqing | / | / | / | / | / | 4918.15 |

In some embodiments, the processing device may determine emission parameters based on the spatialized full-life-cycle carbon emission dataset, the emission parameters including a feeding rate corresponding to a combustion device in a target region and a circulation frequency corresponding to an exhaust gas treatment device in the target region; the processing device may control, based on the feeding rate, a reactor in the combustion device to perform a raw material feeding operation; and the processing device may control, based on the circulation frequency, a circulation pump in the exhaust gas treatment device to perform a circulation treatment operation on emitted exhaust gas.

The emission parameters refer to parameters related to carbon emissions and are used to adjust an implied carbon emission intensity of carbon emission devices in the target region. In some embodiments, the emission parameters may include the feeding rate corresponding to the combustion device in the target region and the circulation frequency corresponding to the exhaust gas treatment device in the target region, or the like.

The target region refers to a region in an accounting region where carbon emissions need to be treated.

In some embodiments, the processing device may determine the target region in various manners. For example, the processing device may determine whether carbon emissions in each accounting region satisfy a first preset condition based on the spatialized full-life-cycle carbon emission dataset; in response to determining that an accounting region satisfies the first preset condition, the accounting region is determined as the target region. The first preset condition refers to that a coal consumption CO₂ emission factor of the accounting region is greater than a first threshold. The first threshold may be preset based on prior knowledge.

In some embodiments, the processing device may determine whether the carbon emissions in the accounting region satisfy the second preset condition based on the spatialized full-life-cycle carbon emission dataset; in response to determining that the accounting region satisfies the second preset condition, the accounting region is determined as the target region. The second preset condition refers to that a two-stage coal consumption CO₂ emission factor of the accounting region is greater than a second threshold. The second threshold may be preset based on prior knowledge.

In some embodiments, the processing device may determine whether the carbon emissions in an accounting region satisfy a third preset condition based on the spatialized full-life-cycle carbon emission dataset; in response to determining that the accounting region satisfies the third preset condition, the accounting region is determined as the target region. The third preset condition refers to that a one-stage coal consumption CO₂ emission factor of the accounting region is greater than a third threshold. The third threshold may be preset based on prior knowledge.

The combustion device refers to a device configured to generate thermal energy or power through a combustion reaction of the primary energy or a secondary energy. For example, the combustion device may include a coal-fired boiler, a reactor, or a gas combustion furnace. The reactor refers to a component configured to combust the primary energy. By controlling a feeding rate of the reactor, a strength and efficiency of the combustion reaction may be adjusted, and an embedded carbon emission intensity may thereby be affected.

The feeding rate refers to a mass or volume of the primary energy and the secondary energy input into the combustion device per unit time.

The exhaust gas treatment device refers to a device configured to treat the emitted exhaust gas generated from the combustion device after combustion. For example, the exhaust gas treatment device may include a desulfurization device, a denitrification device, a circulation pump, or the like. The circulation pump refers to a device configured to perform circulation treatment on the emitted exhaust gas. By adjusting the circulation frequency of the circulation pump, the processing capacity of the emitted exhaust gas can be dynamically controlled, thereby regulating the carbon emissions.

The circulation frequency refers to a frequency or rate at which the exhaust gas treatment device treats the emitted exhaust gas.

In some embodiments, the processing device may determine the emission parameters in various ways. For example, in response to determining that the target region meets the first preset condition, the processing device may determine one or more coal-fired power plants in the target region that contribute to a coal consumption CO₂ emission factor, and increase the circulation frequency of the exhaust gas treatment device in the coal-fired power plant(s).

In some embodiments, in response to determining that the target region meets the second preset condition or the third preset condition, the processing device may query a type of coal-fired power plant that contributes to the two-stage coal consumption CO₂ emission factor or the one-stage coal consumption CO₂ emission factor in the target region, and decrease the feeding rate of the reactor in the combustion device in such coal-fired power plants.

The type of coal-fired power plant includes a traditional coal-fired power plant, a coal-fired power plant adopting an Integrated Gasification Combined Cycle (IGCC), a coal-fired power plant adopting a pre-combustion carbon capture technology, or the like. In response to determining that the target region meets the second preset condition, i.e., the two-stage coal-fired power consumption CO₂ emission factor is greater than the second threshold, the feeding rate of the reactor of the combustion device in the traditional coal-fired power plants in the target region is decreased; in response to determining that the target region meets the third preset condition, i.e., the one-stage coal-fired power consumption CO₂ emission factor is greater than the third threshold, the feeding rate of the reactor of the combustion device in the coal-fired power plants adopting the Integrated Gasification Combined Cycle or the pre-combustion carbon capture technology in the target region is decreased.

In some embodiments, the processing device may determine the target region to be monitored based on the spatialized full-life-cycle carbon emission dataset and an index database; determine one or more monitoring devices to be activated in the target region and the monitoring frequency of each of the monitoring devices based on the index database; activate the one or more monitoring devices in the target region and control the one or more monitoring devices to monitor the target region according to their respective monitoring frequencies to detect a first carbon distribution of the target region; and determine the emission parameters based on the first carbon distribution and the index database.

The index database refers to a database related to carbon emission indicators. The index database may include the carbon emission indicators of different types of coal-fired power plants in different regions. The index database may be pre-constructed based on historical data or prior knowledge. The carbon emission indicators refer to indicators related to the embedded carbon emission intensity. For example, the carbon emission indicators in the index database may include the coal consumption CO₂ emission factor, the two-stage coal power consumption CO₂ emission factor, the one-stage coal power consumption CO₂ emission factor, or the like.

In some embodiments, the processing device may determine the target region to be monitored based on the spatialized full-life-cycle carbon emission dataset and the index database. Specifically, for each accounting region, the processing device may extract the carbon emission indicators of various types of coal-fired power plants in the accounting region from the index database, and take the maximum value among the coal consumption CO₂ emission factor, the two-stage coal consumption CO₂ emission factor, and the one-stage coal consumption CO₂ emission factor in this region as a reference indicator. The processing device may compare the coal consumption CO₂ emission factor, the two-stage coal power consumption CO₂ emission factor, and the one-stage coal power consumption CO₂ emission factor of the accounting region in the spatialized full-life-cycle carbon emission dataset with the reference indicator. In response to determining that any one of the emission factors of the accounting region is higher than the reference indicator, the accounting region is determined as the target region to be monitored.

In some embodiments, the processing device may acquire the carbon emission indicators corresponding to all types of coal-fired power plants in the target region from the index database; and determine a count of monitoring devices to be activated in the target region based on values of the carbon emission indicators. The count of monitoring devices to be activated is positively correlated with the carbon emission indicators. For example, the higher the carbon emission indicators are, the greater the count of monitoring devices to be activated.

In some embodiments, the processing device may determine an activation sequence of the one or more monitoring devices in the target region based on a hierarchical activation table and the count of monitoring devices to be activated, and sequentially activate the monitoring devices. The hierarchical activation table may include a correspondence relationship between monitoring devices, coal-fired power plants to which the monitoring devices belong, and activation priorities. The processing device may sequentially activate the monitoring devices in a descending order of activation priorities specified in the hierarchical activation table based on the count of monitoring devices to be activated, until the count of activated monitoring devices reach the count of monitoring devices to be activated. The hierarchical activation table may be constructed in advance based on historical data or prior knowledge.

In some embodiments, the processing device may determine a monitoring frequency of each monitoring device based on a carbon emission indicator of a coal-fired power plant to which the monitoring device belongs. The monitoring frequency is positively correlated with the carbon emission indicator. For example, the carbon emission indicator increases, the monitoring frequency also increases.

The first carbon distribution refers to real-time carbon emission indicators of coal-fired power plants in the target region. For example, the first carbon distribution may be expressed as (n₁, x₁, y₁, z₁), (n₂, x₂, y₂, z₂), (n₃, x₃, y₃, z₃) . . . , where (n₁, x₁, y₁, z₁) represents that the coal-fired power plant n₁ has a coal consumption CO₂ emission factor x₁, a two-stage coal power consumption CO₂ emission factor y₁, and a one-stage coal power consumption CO₂ emission factor z₁ at the time point t₁. The rest are similar and will not be repeated here.

In some embodiments, the processing device may control the monitoring devices in the target region to be activated and to perform carbon emission detection according to their respective monitoring frequencies, and determine the first carbon distribution of the target region based on data detected by the monitoring devices.

The processing device may further determine the emission parameters based on the first carbon distribution and the index database. In some embodiments, in response to determining that a two-stage coal power consumption CO₂ emission factor of a specific coal-fired power plant in the first carbon distribution is greater than a first reference emission factor, a feeding rate of the reactor of the combustion device of this coal-fired power plant is reduced; in response to determining that the two-stage coal power consumption CO₂ emission factor of the coal-fired power plant is less than or equal to the first reference emission factor, the feeding rate of the reactor of the combustion device of this coal-fired power plant is not adjusted, so as to maintain current emission parameters. The first reference emission factor refers to an average value of two-stage coal power consumption CO₂ emission factors of the same type as the specific coal-fired power plant in different regions in the index database.

In some embodiments, in response to determining that a one-stage coal power consumption CO₂ emission factor of a specific coal-fired power plant in the first carbon distribution is greater than a second reference emission factor, the feeding rate of the reactor of the combustion device of this coal-fired power plant is reduced; in response to determining that the one-stage coal power consumption CO₂ emission factor of the coal-fired power plant is less than or equal to the second reference emission factor, the feeding rate of the reactor of the combustion device of this coal-fired power plant is not adjusted, so as to maintain current emission parameters. The second reference emission factor refers to an average value of one-stage coal power consumption CO₂ emission factors of the same type as the specific coal-fired power plant in different regions in the index database.

In some embodiments, in response to determining that a coal consumption CO₂ emission factor of a specific coal-fired power plant in the first carbon distribution is greater than a third reference emission factor, the circulation frequency of a circulation pump of the exhaust gas treatment device of this coal-fired power plant is increased; in response to determining that the coal consumption CO₂ emission factor of the coal-fired power plant is less than or equal to the third reference emission factor, the circulation frequency of the circulation pump of the exhaust gas treatment device of this coal-fired power plant is not adjusted, so as to maintain current emission parameters. The third reference emission factor refers to an average value of coal consumption CO₂ emission factors of the same type as the specific coal-fired power plant in different regions in the index database.

In some embodiments of the present disclosure, the first carbon distribution is obtained through the monitoring devices, and the emission parameters are determined based on the first carbon distribution and the index database, such that when an embedded carbon emission level in the full-life-cycle of an energy product is excessively high, the feeding rate of the combustion device or the circulation frequency of an exhaust gas treatment device can be dynamically adjusted in a timely manner. As such, the emission parameters can be dynamically generated and adjusted based on a real-time emission state, which facilitates more efficient governance of carbon emissions.

In some embodiments, in response to determining that the first carbon distribution meets the determination condition, scheduling parameters may be determined; based on the scheduling parameters, a scheduling packet may be sent to an unmanned vehicle cluster through a heterogeneous communication network, wherein the scheduling packet includes inspection parameters of one or more unmanned vehicles in the unmanned vehicle cluster; based on the inspection parameters, the one or more unmanned vehicles are controlled to travel to the target region for inspection to detect a second carbon distribution of the target region; and the emission parameters are determined based on the second carbon distribution and the index database.

The scheduling parameters refer to parameters related to scheduling unmanned vehicles to perform inspection tasks. For example, the scheduling parameters may include a device identification number or scheduling priority parameter of an unmanned vehicle, a scheduling time of the unmanned vehicle, or the like.

In some embodiments, in response to determining that the first carbon distribution meets the determination condition, the scheduling parameters may be determined by the processing device. The determination condition includes that one or more coal-fired power plants in the first carbon distribution lack real-time carbon emission indicators. The processing device may determine the coal-fired power plant(s) as one or more target coal-fired power plants.

In some embodiments, the processing device may activate one or more unmanned vehicles located in or around the target coal-fired power plant(s) based on the scheduling parameters to guide the one or more unmanned vehicles to perform inspection in the target coal-fired power plant(s), thereby obtaining real-time carbon emission indicators of the target coal-fired power plant(s). one or more monitoring devices may be mounted on each unmanned vehicle.

In some embodiments, the processing device may send the scheduling packet to the unmanned vehicle cluster through a LoRa-WAN heterogeneous communication network based on the scheduling parameters, where the scheduling packet includes inspection parameters of one or more unmanned vehicles in the unmanned vehicle cluster.

The inspection parameters refer to parameters related to inspection by unmanned vehicles. The inspection parameters may include, but are not limited to, a monitoring duration, an inspection path, an inspection frequency of one or more unmanned vehicles, or the like. The inspection parameters may be preset based on prior knowledge.

The second carbon distribution refers to real-time carbon emission indicators of the target coal-fired power plant(s). A format of the second carbon distribution is similar to that of the first carbon distribution.

In some embodiments, the processing device may control one or more unmanned vehicles in the unmanned vehicle cluster to perform inspection in the target coal-fired power plant(s) based on the inspection parameters, and perform carbon emission detection using onboard monitoring devices. The processing device may determine the second carbon distribution of the target coal-fired power plant(s) based on data detected by the onboard monitoring devices.

The processing device may further determine the emission parameters based on the second carbon distribution and the index database. In some embodiments, in response to a determination that a two-stage coal power consumption CO₂ emission factor corresponding to a specific target coal-fired power plant is greater than the first reference emission factor, the feeding rate of the reactor in the combustion device of the target coal-fired power plant is reduced; in response to a determination that the two-stage coal power consumption CO₂ emission factor corresponding to the target coal-fired power plant is not greater than the first reference emission factor, the feeding rate of the reactor in the combustion device of the target coal-fired power plant is not adjusted, so as to maintain current emission parameters.

In some embodiments, in response to a determination that a one-stage coal power consumption CO₂ emission factor corresponding to the target coal-fired power plant is greater than the second reference emission factor, the feeding rate of the reactor in the combustion device of the target coal-fired power plant is reduced; in response to a determination that the one-stage coal power consumption CO₂ emission factor corresponding to the target coal-fired power plant is not greater than the second reference emission factor, the feeding rate of the reactor in the combustion device of the target coal-fired power plant is not adjusted, so as to maintain current emission parameters.

In some embodiments, in response to a determination that a coal consumption CO₂ emission factor corresponding to the target coal-fired power plant is greater than the third reference emission factor, the circulation frequency of the exhaust gas treatment device of the target coal-fired power plant is increased; in response to a determination that the coal consumption CO₂ emission factor corresponding to the target coal-fired power plant is not greater than the third reference emission factor, the circulation frequency of the exhaust gas treatment device of the target coal-fired power plant is not adjusted, so as to maintain current emission parameters.

In some embodiments of the present disclosure, by determining the scheduling parameters and sending the scheduling packet including inspection parameters to the unmanned vehicle cluster through the LoRa-WAN heterogeneous communication network to drive the unmanned vehicles to perform the inspection operations, the carbon emission indicators of coal-fired power plants that lack real-time embedded carbon emission indicators may be dynamically supplemented and collected, thereby improving the accuracy and comprehensiveness of the emission parameters and enhancing the monitoring capability of the full-life-cycle embedded carbon emissions of energy products.

In some embodiments, the processing device may control the reactor in the combustion device of a coal-fired power plant in the target region to perform a raw material feeding operation at the feeding rate based on the feeding rate in the emission parameters.

In some embodiments, the processing device may control the circulation pump of the exhaust gas treatment device of a coal-fired power plant in the target region to perform a circulation treatment operation on the emitted exhaust gas at the circulation frequency based on the circulation frequency in the emission parameters.

In some embodiments of the present disclosure, the emission parameters are generated based on the spatialized full-life-cycle carbon emission dataset, and a reactor in the combustion device and a circulation pump in the exhaust gas treatment device in the target region are controlled to perform the raw material feeding operation and the circulation treatment operation, respectively, thereby enabling fine-grained regulation of embedded carbon emissions in the full-life-cycle of energy products and achieving targeted control of embedded carbon emissions.

In some embodiments, a system for tracking spatial flow directions of carbon emissions in an energy industry chain comprises the following modules: a spatialized full-life-cycle carbon emission calculation module for energy production and consumption, a full-life-cycle carbon emission spatial flow calculation module for energy production and consumption, and a spatialized full-life-cycle carbon emission and flow data module for energy production and consumption.

The spatialized full-life-cycle carbon emission calculation module for energy production and consumption is configured to establish a spatialized full-life-cycle carbon emission accounting model for energy production and consumption of a primary energy and a secondary energy, and determine the spatialized full-life-cycle carbon emission dataset for the energy production and consumption that meets a preset second quality evaluation requirements. More descriptions regarding how to establish the spatialized full-life-cycle carbon emission accounting model may be found in other contents of the present disclosure (e.g., descriptions in connection with steps S1.1-S1.2). More descriptions regarding how to determine the spatialized full-life-cycle carbon emission dataset may be found in other contents of the present disclosure (e.g., descriptions in connection with step S3).

In some embodiments, the spatialized full-life-cycle carbon emission calculation module for energy production and consumption further includes a spatialized full-life-cycle carbon emission calculation and integration module for energy production and consumption, a spatialized full-life-cycle carbon emission data verification module for energy production and consumption, and a spatialized full-life-cycle carbon emission data storage and management module for energy production and consumption.

The spatialized full-life-cycle carbon emission calculation and integration module for energy production and consumption is configured to preliminarily determine the spatialized full-life-cycle carbon emission dataset for energy production and consumption based on the spatialized full-life-cycle carbon emission accounting model for energy production and consumption of the primary energy and the secondary energy, by inputting the energy industry chain dataset that meets a preset first quality evaluation requirements. More descriptions regarding how to determine the spatialized full-life-cycle carbon emission dataset for the energy production and consumption may be found in other contents of the present disclosure (e.g., descriptions in connection with step S3.4).

In some embodiments, the spatialized full-life-cycle carbon emission data verification module for energy production and consumption is configured to perform data verification on the spatialized full-life-cycle carbon emission dataset for the energy production and consumption and to compile the first data verification report. For example, the spatialized full-life-cycle carbon emission data verification module for the energy production and consumption may verify whether there are missing fields in the spatialized full-life-cycle carbon emission dataset or whether there are contradictions between data from different sources, or the like. The first data verification report refers to the verification report related to the spatialized full-life-cycle carbon emission dataset. For example, the first data verification report may include whether the spatialized full-life-cycle carbon emission dataset meets preset second quality evaluation requirements.

In some embodiments, the spatialized full-life-cycle carbon emission data storage and management module for the energy production and consumption is configured to store and manage the spatialized full-life-cycle carbon emission dataset for the energy production and consumption that has passed data verification.

In some embodiments, the full-life-cycle carbon emission spatial flow calculation module for energy production and consumption is configured to establish the full-life-cycle carbon emission spatial flow tracking model for the two-stage production and consumption from the primary energy to the secondary energy and a one-stage production and consumption of the secondary energy, and to determine the full-life-cycle carbon emission spatial flow dataset for the energy production and consumption that meets the preset third quality evaluation requirements. More descriptions regarding how to establish the full-life-cycle carbon emission spatial flow tracking model may be found in other contents of the present disclosure (e.g., descriptions in connection with steps S2.1 to S2.6). More descriptions regarding how to determine the full-life-cycle carbon emission spatial flow dataset may be found in other contents of the present disclosure (e.g., descriptions in connection with step S3.6).

In some embodiments, the full-life-cycle carbon emission spatial flow calculation module for energy production and consumption further comprises a full-life-cycle carbon emission spatial flow identification module for the energy production and consumption, a full-life-cycle carbon emission spatial flow calculation and integration module for the energy production and consumption, a full-life-cycle carbon emission spatial flow data verification module for the energy production and consumption, and a full-life-cycle carbon emission spatial flow data storage and management module for the energy production and consumption.

In some embodiments, the full-life-cycle carbon emission spatial flow identification module for the energy production and consumption is configured to identify the flow characteristics of carbon emissions between regions along the energy industry chain of the primary energy production—the secondary energy conversion—the final energy consumption process under different application scenarios. More descriptions regarding the flow characteristics may be found in other contents of the present disclosure (e.g., descriptions in connection with step S2).

In some embodiments, the full-life-cycle carbon emission spatial flow calculation and integration module for energy production and consumption is configured to, based on a full-life-cycle carbon emission spatial flow tracking model for a two-stage production and consumption from a primary energy to a secondary energy and a one-stage production and consumption of the secondary energy, input an energy industry chain dataset meeting a preset first quality evaluation requirements and a spatialized full-life-cycle carbon emission dataset for energy production and consumption meeting a preset second quality evaluation requirement, to preliminarily calculate a full-life-cycle carbon emission spatial flow dataset for energy production and consumption. More descriptions regarding the full-life-cycle carbon emission spatial flow dataset may be found in other contents of the present disclosure (e.g., descriptions in connection with step S3.6).

In some embodiments, the full-life-cycle carbon emission spatial flow data verification module for the energy production and consumption is configured to perform the data verification on the full-life-cycle carbon emission spatial flow dataset for the energy production and consumption and compile the second data verification report. The second data verification report refers to a verification report related to the full-life-cycle carbon emission spatial flow dataset. For example, the second data verification report may include whether the full-life-cycle carbon emission spatial flow dataset meets a preset third quality evaluation requirements or the like.

In some embodiments, the full-life-cycle carbon emission spatial flow data storage and management module for the energy production and consumption is configured to store and manage the full-life-cycle carbon emission spatial flow dataset for the energy production and consumption that has passed the data verification.

In some embodiments, the spatialized full-life-cycle carbon emission and flow data module for energy production and consumption is configured to, based on the accounting object, determine the energy industry chain data source by identifying boundaries of an accounting system, and integrate and manage the spatialized full-life-cycle carbon emission dataset for the energy production and consumption that meets the preset second quality evaluation requirements and the full-life-cycle carbon emission spatial flow dataset that meets the preset third quality evaluation requirements. More descriptions regarding integrating the spatialized full-life-cycle carbon emission dataset and the full-life-cycle carbon emission spatial flow dataset for the energy production and consumption may be found in other contents of the present disclosure (e.g., descriptions in connection with steps S3.4 and S3.6).

In some embodiments, the spatialized full-life-cycle carbon emission and flow data module for energy production and consumption further includes: an energy industry chain data source definition module; energy industry chain data acquisition module; an energy industry chain data processing module; a spatialized full-life-cycle carbon emission and flow data integration and management module for the energy production and consumption; a spatialized full-life-cycle carbon emission and flow data publishing module for the energy production and consumption; and a spatialized full-life-cycle carbon emission and flow data updating module for the energy production and consumption.

In some embodiments, the energy industry chain data source definition module is configured to determine the energy industry chain data source according to the accounting object by identifying the boundaries of an accounting system. More descriptions regarding determining the energy industry chain data source may be found in other contents of the present disclosure (e.g., descriptions in connection with step S3.1).

In some embodiments, the energy industry chain data collection module is configured to collect energy production data, energy conversion data, energy consumption data, energy flow data, and the embedded carbon emission intensity data based on the energy industry chain data source to construct the initial dataset of the energy industry chain. More descriptions regarding constructing the initial dataset of the energy industry chain may be found in other contents of the present disclosure (e.g., descriptions in connection with step S3.2).

In some embodiments, the energy industry chain data processing module is configured to check the initial dataset of the energy industry chain, convert the initial dataset of the energy industry chain into a unified format, and determine the energy industry chain dataset that meets a preset first quality evaluation requirements. More descriptions regarding determining the energy industry chain dataset may be found in other contents of the present disclosure (e.g., descriptions in connection with step S3.3).

In some embodiments, the spatialized full-life-cycle carbon emission and flow data integration and management module for energy production and consumption is configured to, based on the energy industry chain dataset that meets the preset first quality evaluation requirement, the preliminarily determined spatialized full-life-cycle carbon emission dataset for energy production and consumption, and the preliminarily determined full-life-cycle carbon emission spatial flow dataset, determine the spatialized full-life-cycle carbon emission dataset for energy production and consumption that meets a preset second quality evaluation requirements and the full-life-cycle carbon emission spatial flow dataset that meets the preset third quality evaluation requirements. More descriptions regarding determining the full-life-cyclo carbon emission spatial flow dataset may be found in other contents of the present disclosure (e.g., descriptions in connection with step S3.6).

In some embodiments, the spatialized full-life-cycle carbon emission and flow data publishing module for the energy production and consumption is configured to publish the spatialized full-life-cycle carbon emission dataset and the full-life-cycle carbon emission spatial flow dataset for the energy production and consumption.

In some embodiments, the spatialized full-life-cycle carbon emission and flow data updating module for the energy production and consumption is configured to update an energy industry chain data source through the energy industry chain data source definition module according to a data updating requirements. Specifically, in response to determining that the spatialized full-life-cycle carbon emission dataset does not meet the second quality evaluation requirements or that the full-life-cycle carbon emission spatial flow dataset does not meet the third quality evaluation requirement, the data updating requirements is considered to exist, and the energy industry chain data source needs to be re-determined. More descriptions may be found in other contents of the present disclosure (e.g., descriptions in connection with step S3.5).

In some embodiments, the modules described above may be implemented on the processing device 110.

In some embodiments of the present disclosure further provide a computer program product, which may include a computer-readable storage medium. When a computer reads computer instructions stored in the storage medium, the computer executes any of the methods described in the above embodiments. The computer-readable storage medium may be a tangible device that stores and holds instructions for use by an instruction execution device. The computer-readable storage medium may include, but is not limited to, an electrical storage device, a magnetic storage device, an optical storage device, an electromagnetic storage device, a semiconductor storage device, or any combination thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for tracking spatial flow directions of carbon emissions in an energy industry chain, comprising:
S1, modeling a primary energy production, a secondary energy conversion, or a final energy consumption process corresponding to spatial locations at specific sites based on a general multi-flow multi-node model to construct a spatialized full-life-cycle carbon emission accounting model for an energy production and consumption of a primary energy and a secondary energy;
S2, determining, based on the spatialized full-life-cycle carbon emission accounting model of the energy production and consumption, flow characteristics of carbon emissions between regions along the energy industry chain of the primary energy production—the secondary energy conversion—the final energy consumption process under different application scenarios, and constructing a full-life-cycle carbon emission spatial flow tracking model for a two-stage production and consumption from the primary energy to the secondary energy, and a one-stage production and consumption of the secondary energy; and
S3, determining, based on an accounting object, an initial dataset of the energy industry chain, substituting the initial dataset of the energy industry chain into the spatialized full-life-cycle carbon emission accounting model for the energy production and consumption of the primary energy and the secondary energy, and into the full-life-cycle carbon emission spatial flow tracking model for the two-stage production and consumption from the primary energy to the secondary energy and the one-stage production and consumption of the secondary energy, to determine a spatialized full-life-cycle carbon emission dataset and a full-life-cycle carbon emission spatial flow dataset of the energy production and consumption that meet quality evaluation requirements.

2. The method of claim 1, wherein in step S1, the spatialized full-life-cycle carbon emission accounting model is constructed by:
S1.1, establishing product flow input-output balance equations at nodes on a provincial scale for the energy production and consumption of the primary energy and the secondary energy based on a production flow, a transportation flow, and a consumption flow in the energy industry chain; and
S1.2, establishing, based on the product flow input-output balance equations, embedded carbon emission flow input-output balance equations at the nodes on the provincial scale for the energy production and consumption of the primary energy and the secondary energy.

3. The method of claim 2, wherein the product flow input-output balance equations are expressed as:
$$\{ \begin{matrix}{PP}_{ii} + {\sum }_{j , j \neq i} {tr}_{ji} = {PC}_{ii} + {\sum }_{j , j \neq i} {tr}_{ij} \\ {SP}_{ii} + {\sum }_{k , k \neq i} {ts}_{ki} = {SC}_{ii} + {\sum }_{k , k \neq i} {ts}_{ik}\end{matrix}$$
wherein PPᵢᵢ denotes a production flow input of the primary energy in a province i; trⱼᵢ denotes a transportation flow input of the primary energy from a province j to the province i; PCᵢᵢ denotes a consumption flow output of the primary energy in the province i; trᵢⱼ denotes a transportation flow output of the primary energy from the province i to the province j; SPᵢᵢ denotes a production flow input of the secondary energy in the province i; tsₖᵢ denotes a transportation flow input of the secondary energy from a province k to the province i; SCᵢᵢ denotes a consumption flow output of the secondary energy in the province i; and tsᵢₖ denotes a transportation flow output of the secondary energy from the province i to the province k.
the embedded carbon emission flow input-output balance equations are expressed as:
$$\{ \begin{matrix}{PP}_{ii} \cdot {a}_{i} + {\sum }_{j , j \neq i} {tr}_{ji} \cdot {b}_{j} = ( {PC}_{ii} + {\sum }_{j , j \neq i} {tr}_{ij} ) \cdot {b}_{i} \\ {SP}_{ii} \cdot \frac{{b}_{i}}{{c}_{i}} + {\sum }_{k , k \neq i} {ts}_{ki} \cdot {d}_{k} = ( {SC}_{ii} + {\sum }_{k , k \neq i} {ts}_{ik} ) \cdot {d}_{i}\end{matrix}$$
wherein aᵢ denotes an embedded carbon emission intensity corresponding to the production flow input of the primary energy in the province i; bⱼ denotes an embedded carbon emission intensity corresponding to the transportation flow input of the primary energy from the province j to the province i; bᵢ denotes an embedded carbon emission intensity corresponding to the consumption flow output of the primary energy in the province i; cᵢ denotes a conversion coefficient from the primary energy to the secondary energy in the province i; dₖ denotes a carbon emission intensity of the primary energy embedded in the transportation flow input of the secondary energy from the province k to the province i; and dᵢ denotes an embedded carbon emission intensity corresponding to the consumption flow output of the secondary energy in the province i, and
$${SP}_{ii} \cdot {e}_{i} + {\sum }_{k , k \neq i} {ts}_{ki} \cdot {f}_{k} = ( {SC}_{ii} + {\sum }_{k , k \neq i} {ts}_{ik} ) \cdot {f}_{i}$$
wherein eᵢ denotes an embedded carbon emission intensity corresponding to the production flow input of the secondary energy in the province i; fₖ denotes an embedded carbon emission intensity corresponding to the transportation flow input of the secondary energy from the province k to the province i; and fᵢ denotes an embedded carbon emission intensity corresponding to the consumption flow output of the secondary energy in the province i.

4. The method of claim 1, wherein in step S2, the full-life-cycle carbon emission spatial flow tracking model is constructed by:
S2.1, in response to determining that the primary energy production occurs in the province j, the secondary energy conversion occurs in the province i, and the final energy consumption process occurs in the province k, constructing the full-life-cycle carbon emission spatial flow tracking model for the two-stage production and consumption from the primary energy to the secondary energy as follows:
$${s}_{jik} = \frac{{tr}_{ji} \cdot {b}_{j}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{ts}_{ik} \cdot {d}_{i}}{( {SC}_{ii} + {\sum }_{k , k \neq i} {ts}_{ik} ) \cdot {d}_{i}}$$
wherein sⱼᵢₖ denotes a spatial flow quantity of carbon emissions along the energy industry chain of the primary energy production—the secondary energy conversion—the final energy consumption process between the province j, the province i, and the province k;
S2.2, in response to determining that the primary energy production occurs in the province j, the secondary energy conversion occurs in the province i, and the final energy consumption process occurs in the province i, constructing the full-life-cycle carbon emission spatial flow tracking model for the two-stage production and consumption from the primary energy to the secondary energy as follows:
$${s}_{jii} = \frac{{tr}_{ji} \cdot {b}_{j}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{SC}_{ii} \cdot {d}_{i}}{( {SC}_{ii} + {\sum }_{k , k \neq i} {ts}_{ik} ) \cdot {d}_{i}}$$
wherein Sⱼᵢᵢ denotes a spatial flow quantity of carbon emissions along the energy industry chain of the primary energy production—the secondary energy conversion—the final energy consumption process between the province j, the province i, and the province i;
S2.3, in response to determining that the primary energy production occurs in the province i, the secondary energy conversion occurs in the province i, and the final energy consumption process occurs in the province k, constructing the full-life-cycle carbon emission spatial flow tracking model for the two-stage production and consumption from the primary energy to the secondary energy as follows:
$${s}_{iik} = \frac{{PP}_{ii} \cdot {a}_{i}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{ts}_{ik} \cdot {d}_{i}}{( {SC}_{ii} + {\sum }_{k , k \neq i} {ts}_{ik} ) \cdot {d}_{i}}$$
wherein Sᵢᵢₖ denotes a spatial flow quantity of carbon emissions along the energy industry chain of the primary energy production—the secondary energy conversion—the final energy consumption process between the province i, the province i, and the province k;
S2.4, in response to determining that the primary energy production occurs in the province i, the secondary energy conversion occurs in the province i, and the final energy consumption process occurs in the province i, constructing the full-life-cycle carbon emission spatial flow tracking model for the two-stage production and consumption from the primary energy to the secondary energy as follows:
$${s}_{iii} = \frac{{PP}_{ii} \cdot {a}_{i}}{{PP}_{ii} \cdot {a}_{i} + {\sum }_{j , j \neq i} {tr}_{ji} \cdot {b}_{j}} \cdot {SP}_{ii} \cdot \frac{{b}_{i}}{{c}_{i}} \cdot \frac{{SC}_{ii} \cdot {d}_{i}}{( {SC}_{ii} + {\sum }_{k , k \neq i} {ts}_{ik} ) \cdot {d}_{i}}$$
wherein Sᵢᵢᵢ denotes a spatial flow quantity of carbon emissions along the energy industry chain of the primary energy production—the secondary energy conversion—the final energy consumption process between the province i, the province i, and the province i;
S2.5, in response to determining that the secondary energy conversion occurs in the province k and the final energy consumption process occurs in the province i, constructing the full-life-cycle carbon emission spatial flow tracking model for the one-stage production and consumption of the secondary energy as follows:
$${t}_{ki} = \frac{{ts}_{ki} \cdot {f}_{k}}{{SP}_{ii} \cdot {e}_{i} + {\sum }_{k , k \neq i} {ts}_{ki} \cdot {f}_{k}} \cdot {SC}_{ii} \cdot {f}_{i}$$
wherein tₖᵢ denotes a spatial flow quantity of carbon emissions along an energy industry chain of the secondary energy conversion—the final energy consumption process between the province k and the province i;
S2.6, in response to determining that the secondary energy conversion occurs in the province i and the final energy consumption process occurs in the province i, constructing the full-life-cycle carbon emission spatial flow tracking model for the one-stage production and consumption of the secondary energy as follows:
$${t}_{ii} = \frac{{SP}_{ii} \cdot {e}_{i}}{{SP}_{ii} \cdot {e}_{i} + {\sum }_{k , k \neq i} {ts}_{ki} \cdot {f}_{k}} \cdot {SC}_{ii} \cdot {f}_{i}$$
wherein tᵢᵢ denotes a spatial flow quantity of carbon emissions along the energy industry chain of the secondary energy conversion—the final energy consumption process between the province i and the province i.

5. The method of claim 1, wherein the S3 includes:
S3.1, determining an energy industry chain data source according to the accounting object by identifying boundaries of an accounting system;
S3.2, collecting, based on the energy industry chain data source, production data, conversion data, consumption data, flow data of energy products, and embedded carbon emission intensity data to form the initial dataset of the energy industry chain;
S3.3, checking the initial dataset of the energy industry chain, converting the initial dataset of the energy industry chain into a unified data format, and inputting the converted dataset into the spatialized full-life-cycle carbon emission accounting model for the energy production and consumption of the primary energy and the secondary energy to perform a quality evaluation on an accounting result; in response to determining that the accounting result does not meet preset quality evaluation requirements, proceeding to the S3.1 to re-determine the energy industry chain data source; otherwise, proceeding to the S3.4;
S3.4, integrating the accounting result that meets the preset quality evaluation requirements to determine the spatialized full-life-cycle carbon emission dataset of the energy production and consumption;
S3.5, extracting an energy industry chain dataset and a spatialized full-life-cycle carbon emission dataset of that the energy production and consumption that meet the preset quality evaluation requirements, and inputting the extracted datasets into the full-life-cycle carbon emission spatial flow tracking model for the two-stage production and consumption from the primary energy to the secondary energy and for the one-stage production and consumption of the secondary energy to perform a quality evaluation on the accounting result; in response to determining that the accounting result does not meet the preset quality evaluation requirements, proceeding to the S3.1 to re-determine the energy industry chain data source; otherwise, proceeding to the S3.6; and
S3.6, integrating the accounting result that meets the preset quality evaluation requirements to determine the full-life-cycle carbon emission spatial flow dataset of the energy production and consumption.
